(19) United States
(12) Patent Application Publication
(10) Pub. No.: US 2023/0194918 A1
(43) Pub. Date: Jun. 22, 2023

(54) OPTICAL DIMMING LENS AND FABRICATION METHOD THEREOF

(71) Applicant: Meta Platforms Technologies, LLC, Menlo Park, CA (US)

(72) Inventors: Sho NAKAHARA, Bothell, WA (US); Afsoon JAMALI, Issaquah, WA (US); Ming LEI, Bellevue, WA (US); Rongzhi HUANG, Sammamish, WA (US)

(21) Appl. No.: 17/983,944

(22) Filed: Nov. 9, 2022

Related U.S. Application Data
(60) Provisional application No. 63/292,471, filed on Dec. 22, 2021.
(60) Provisional application No. 63/353,562, filed on Jun. 18, 2022.

(51) Int. Cl. G02F 1/1335; G02B 5/30

(52) U.S. Cl. CPC G02F 1/133528; G02B 5/3083

(57) ABSTRACT

A lens is provided. The lens includes a first material layer including a first lens material with a first birefringence, a first density, and a first impact resistance. The lens also includes a second material layer coupled with the first material layer and including a second lens material with a second birefringence, a second density, and a second impact resistance. The first birefringence is lower than the second birefringence, the first density is lower than the second density, and the second impact resistance is stronger than the first impact resistance.

### CROSS REFERENCE TO RELATED APPLICATIONS

This application claims the benefit of priority to U.S. Provisional Application No. 63/292,471, filed on Dec. 22, 2021, and to U.S. Provisional Pat. Application No. 63/353,562, filed on Jun. 18, 2022. The contents of the above-referenced applications are incorporated by reference in their entirety.

### TECHNICAL FIELD

The present disclosure relates generally to optical devices and, more specifically, to an optical dimming lens and a fabrication method thereof.

### BACKGROUND

Artificial reality devices, such as a head-mounted displays (“HMDs”) or heads-up display (“HUD”) devices, have wide applications in various fields, including aviation, engineering design, medical surgery practice, and video gaming, etc. The artificial reality devices may display virtual objects or combine images of real objects with virtual objects, as in augmented reality (“AR”), virtual reality (“VR”), and/or mixed reality (“MR”) applications. When implemented for AR and/or MR applications, the artificial reality devices may be at least partially transparent from the perspective of a user, enabling the user to view a surrounding real world environment. When implemented for VR application, the artificial reality devices may be opaque such that the user is substantially immersed in the VR imagery provided via the artificial reality devices.

### SUMMARY OF THE DISCLOSURE

Consistent with an aspect of the present disclosure, a lens is provided. The lens includes a first material layer including a first lens material with a first birefringence, a first density, and a first impact resistance. The lens also includes a second material layer coupled with the first material layer and including a second lens material with a second birefringence, a second density, and a second impact resistance. The first birefringence is lower than the second birefringence, the first density is lower than the second density, and the second impact resistance is stronger than the first impact resistance.

Consistent with another aspect of the present disclosure, a method is provided. The method includes providing a first material layer including a first lens material with a first birefringence, a first density, and a first impact resistance. The method also includes disposing a dimming element at the first material layer. The method also includes disposing a second material layer at the dimming element. The second material layer includes a second lens material with a second birefringence, a second density, and a second impact resistance. The first birefringence is lower than the second birefringence, the first density is lower than the second density, and the second impact resistance is stronger than the first impact resistance.

Consistent with another aspect of the present disclosure, a method is provided. The method includes providing a first material layer including a first lens material with a first birefringence, a first density, and a first impact resistance. The method includes disposing a dimming element into a second material layer. The second material layer includes a second lens material with a second birefringence, a second density, and a second impact resistance. The method includes disposing the second material layer at the first material layer. The first birefringence is lower than the second birefringence, the first density is lower than the second density, and the second impact resistance is stronger than the first impact resistance.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of an artificial reality device, according to an embodiment of the present disclosure;

FIG. 1B schematically illustrates a cross-sectional view of half of the artificial reality device shown in FIG. 1A, according to an embodiment of the present disclosure;

FIG. 1C illustrates an image perceived by a user of the artificial reality device when the artificial reality device shown in FIG. 1A operates in an augmented reality (“AR”) or mixed reality (“MR”) mode, according to an embodiment of the present disclosure;

FIG. 1D illustrates an image perceived by a user of the artificial reality device when the artificial reality device shown in FIG. 1A operates in a virtual reality (“VR”), according to an embodiment of the present disclosure;

FIG. 2A illustrates a schematic diagram of a dimming lens, according to an embodiment of the present disclosure;

FIG. 2B illustrates a schematic diagram of a dimming lens, according to an embodiment of the present disclosure;

FIG. 2C illustrates a schematic diagram of a dimming lens, according to an embodiment of the present disclosure;

FIG. 2D illustrates a schematic diagram of a dimming lens, according to an embodiment of the present disclosure;

FIG. 2E illustrates a schematic diagram of a dimming lens, according to an embodiment of the present disclosure;

FIGS. 3A and 3B illustrate schematic diagrams of a display system including a dimming lens, according to an embodiment of the present disclosure;

FIG. 3C illustrates a schematic diagram of a display system including a dimming lens, according to an embodiment of the present disclosure;

FIG. 3D illustrates a schematic diagram of a display system including a dimming lens, according to an embodiment of the present disclosure;

FIGS. 4A and 4B illustrate schematic diagrams of a dimming element that may be included in a dimming lens, according to an embodiment of the present disclosure;

FIG. 4C illustrates a schematic diagram of a dimming element that may be included in a dimming lens, according to an embodiment of the present disclosure;

FIGS. 5A and 5B illustrate schematic diagrams of a dimming element that may be included in a dimming lens, according to an embodiment of the present disclosure;

FIG. 5C illustrates a schematic diagram of a dimming element that may be included in a dimming lens, according to an embodiment of the present disclosure;

FIGS. 6A and 6B illustrate schematic diagrams of a dimming element that may be included in a dimming lens, according to an embodiment of the present disclosure;

FIG. 6C illustrates a schematic diagram of a dimming element that may be included in a dimming lens, according to an embodiment of the present disclosure;

FIG. 7A is a flowchart illustrating a method for fabricating a dimming lens, according to an embodiment of the present disclosure; and

FIG. 7B is a flowchart illustrating a method for fabricating a dimming lens, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction. The film plane may be a plane in the volume of the film, layer, coating, or plate, or may be a surface plane of the film, layer, coating, or plate.

The term “orthogonal” as in “orthogonal polarizations” or the term “orthogonally” as in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a major portion, including all, of a light is transmitted, reflected, diffracted, or blocked, etc. The major portion may be a predetermined percentage (greater than 50%) of the entire light, such as 100%, 98%, 90%, 85%, 80%, etc., which may be determined based on specific application needs.

Dimming lenses have been used for increasing the dynamic range of artificial reality devices. An optical dimming lens has to meet some properties or performance in order to satisfy product specifications, such as compactness and light weight, a sufficiently strong impact resistance to pass government agency tests, see-through quality with negligible birefringence issues. It is often challenging to meet all these requirements needed for artificial reality devices. The present disclosure provides a dimming lens that provides light weight, strong impact resistance, and low birefringence.

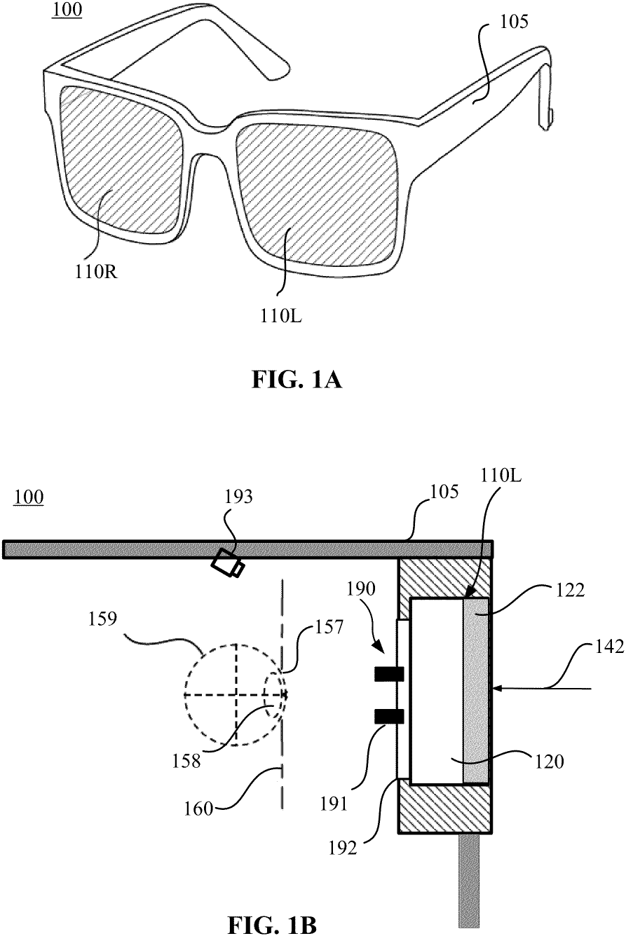

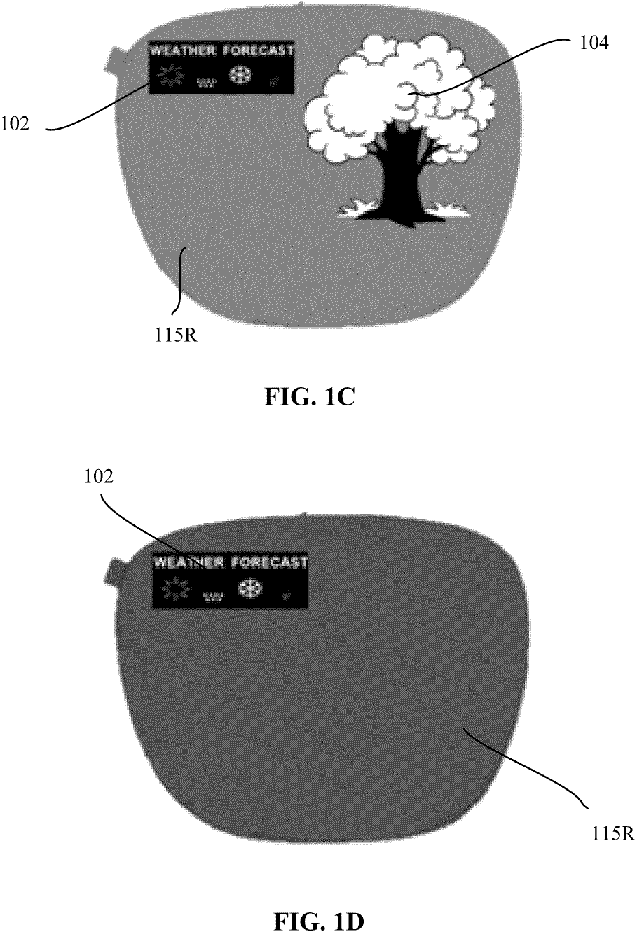

FIG. 1A illustrates a schematic diagram of an artificial reality device 100 according to an embodiment of the present disclosure. In some embodiments, the artificial reality device 100 may produce VR, AR, and/or MR content for a user, such as images, video, audio, or a combination thereof. In some embodiments, the artificial reality device 100 may be smart glasses. In one embodiment, the artificial reality device 100 may be a near-eye display (“NED”). In one embodiment, the artificial reality device 100 may be a head-up display. In some embodiments, the artificial reality device 100 may be in the form of eyeglasses, goggles, a helmet, a visor, or some other type of eyewear. In some embodiments, the artificial reality device 100 may be configured to be worn on a head of a user (e.g., by having the form of spectacles or eyeglasses, as shown in FIG. 1A), or to be included as part of a helmet that is worn by the user. In some embodiments, the artificial reality device 100 may be configured for placement in proximity to an eye or eyes of the user at a fixed location in front of the eye(s), without being mounted to the head of the user. In some embodiments, the artificial reality device 100 may be in a form of eyeglasses that provide vision correction. In some embodiments, the artificial reality device 100 may be in a form of plano-eyeglasses that provide no vision correction. In some embodiments, the artificial reality device 100 may be in a form of sunglasses that protect the eyes of the user from the bright sunlight. In some embodiments, the artificial reality device 100 may be in a form of safety glasses that protect the eyes of the user. In some embodiments, the artificial reality device 100 may be in a form of a night vision device or infrared goggles to enhance a user’s vision at night. The artificial reality device 100 may be implemented in other forms.

For discussion purposes, FIG. 1A shows that the artificial reality device 100 includes a frame 105 configured to mount to a user’s head, and left-eye and right-eye display systems 110L and 110R mounted to the frame 105. FIG. 1B is a cross-sectional view of half of the artificial reality device 100 shown in FIG. 1A according to an embodiment of the present disclosure. For illustrative purposes, FIG. 1B shows the cross-sectional view associated with a left-eye display system 110L. The frame 105 is merely an example structure to which various components of the artificial reality device 100 may be mounted. Other suitable type of fixtures may be used in place of or in combination with the frame 105.

In some embodiments, each of the left-eye and right-eye display systems 110L and 110R may include an image display assembly 120 configured to generate image lights representing computer-generated virtual images, and guide the image lights to an eye-box region 160, where an eye 159 may be positioned to receive the image lights. The eye-box region 160 may include a plurality of exit pupils 157. An exit pupil 157 may be a location where an eye pupil 158 of the eye 159 of the user may be positioned in the eye-box region 160 to receive the image lights. For example, in some embodiments, the image display assembly 120 may include a light source configured to output an image light representing a virtual image, and an image combiner configured to guide the image light received from the light source to the eye-box region 160. In some embodiments, the image combiner may also transmit an ambient light (or a real world light) 142 coming from the real world environment toward the eye-box region 160, thereby combining the image light and the real world light 142, and directing both lights toward the eye-box region 160. Thus, the eye 159 may observe the virtual scene optically combined with the real world scene. The image display assembly 120 may be any suitable image display assembly, and the image combiner may be any suitable image combiner, such as a light guide coupled with an in-coupling element and an out-coupling element, a holographic optical element (“HOE”), etc. For simplicity of illustration, the details of the image display assembly 120 are not shown in FIG. 1B.

In some embodiments, as shown in FIG. 1B, each of the left-eye and right-eye display systems 110L and 110R may include a dimming lens 122 that is formed by two lens material of different material properties. The dimming lens 122 may provide light weight, high impact resistance, and low birefringence. The image display assembly 120 may include an outer side facing the real world environment and an inner side facing the eye-box region 160. The dimming lens 122 may be disposed at the outer side of the image display assembly 120. It is noted that although the elements are shown as having flat surfaces for illustrative purposes, in some embodiments, at least one (e.g., each) of the image display assembly 120 or the dimming lens 122 may include a curved surface. In some embodiments, the dimming lens 122 may be integrally formed with the image display assembly 120, or may be a separate element stacked with the image display assembly 120.

In some embodiments, the dimming lens 122 may be configured to dim an ambient light (or a real world light) 142 coming from the real world environment toward the eye-box region 160. The ambient light 142 coming from the real world environment at the outer side of the left-eye and right-eye display systems 110L and 110R may be incident onto the dimming lens 122 before the ambient light 142 is incident onto the image display assembly 120. The dimming lens 122 may reduce the transmittance of the ambient light 142, or block the ambient light 142 from being incident onto the image display assembly 120, based on a suitable dimming mechanisms, such as polarization, absorption, scattering, and/or diffusion, etc.

In some embodiments, the dimming lens 122 may be a global dimming lens configured with a light transmittance that is uniform over the entire aperture of the dimming lens 122. In other words, the dimming lens 122 may be configured to uniformly dim or attenuate the real-world light 142 over the entire aperture of the dimming lens 122. In some embodiments, the dimming lens 122 may be a regional or local dimming lens configured to provide different light transmittances at different regions (or areas) of the aperture of the dimming lens 122. The light transmittances at the respective regions or portions of the dimming lens 122 for the real-world light 142 may be individually or independently controllable.

In some embodiments, the transmittance or the dimming effect of the dimming lens 122 for the real-world light 142 may be fixed. In some embodiments, the transmittance or the dimming effect of the dimming lens 122 for the real-world light 142 may be adjustable by a suitable external field. In some embodiments, the transmittance or the dimming effect of the dimming lens 122 may be adjustable by adjusting an electric field. For example, the dimming lens 122 may include a dimming material having an electrically tunable transmittance (referred to as an electrically tunable dimming material for discussion purposes), and one or more electrode layers configured to be electrically coupled to a power source (which may provide a voltage to the electrode layers) to provide a tunable electric field in the dimming material. Examples of the electrically tunable dimming material may include a guest-host liquid crystal (“LC”) material (e.g., a host LC doped with guest dyes (e.g., dichroic dyes)), a polymer stabilized cholesteric LC material, suspended particles, an electrochromic material, an electrophoretic material, etc.

In some embodiments, the transmittance or the dimming effect of the dimming lens 122 may be adjustable by a suitable external field other than the electric field, e.g., a magnetic field, a temperature, or a light, etc. For example, in some embodiments, the dimming lens 122 may include a dimming material having a non-electrically tunable transmittance (referred to as a non-electrically tunable dimming material for discussion purposes). The light transmittance of the non-electrically tunable dimming material may be tunable via an approach other than tuning a voltage, e.g., by changes in an ambient light, or a temperature, etc. Examples of non-electrically tunable dimming material may include a photochromic material, a photodichroic material, a thermochromic material, etc. In some embodiments, the dimming material may include both of the electrically tunable dimming material and the non-electrically tunable dimming material to achieve a desirable dimming effect.

In some embodiments, the dimming lens 122 may be an ophthalmic lens with a prescription, e.g., single vision, bifocal, trifocal, or progressive, to provide vision correction to a user’s eyesight. For example, the dimming lens 122 may be configured to alter the ambient light 142 while transmitting the ambient light 142, to provide vision correction to the user’s eyesight. In some embodiments, the dimming lens 122 may be plano-lens that provides no vision correction. For example, in some embodiments, the dimming lens 122 may be configured as a flat or curved slab with zero optical power for the ambient light 142.

In some embodiments, as shown in FIG. 1B, the artificial reality device 100 may also include an object tracking assembly 190 (e.g., eye tracking assembly and/or face tracking assembly). The object tracking assembly 190 may include an infrared (“IR”) light source 191 configured to emit an IR light to illuminate the eye 159 and/or the face, a deflecting element 192 (such as a grating), and an optical sensor 193 (such as a camera). The deflecting element 192 may deflect (e.g., diffract) the IR light reflected by the eye 159 toward the optical sensor 193. The optical sensor 193 may generate a tracking signal relating to the eye 159 based on the IR light deflected by the deflecting element 192. The tracking signal may be an image of the eye 159. The artificial reality device 100 may include a controller (not shown), which may control various optical elements in the left-eye display systems 110L, and/or the object tracking assembly 190.

The artificial reality device 100 may be configured to operate in a VR mode, an AR mode, or an MR mode. The artificial reality device 100 may be configured to be switchable among operating in the VR mode, the AR mode, and/or the MR mode, in both indoor and outdoor environments. In some embodiments, when the artificial reality device 100 operates in the AR or the MR mode, the dimming lens 122 may operate in a clear state or an intermediate state, and the left-eye and right-eye display systems 110L and 110R may be fully or partially transparent from the perspective of the user, which may provide the user with a view of a surrounding real world environment. In some embodiments, when the artificial reality device 100 operates in the VR mode, the dimming lens 122 may operate in an opaque state, and the left-eye and right-eye display systems 110L and 110R may be opaque to block the light from the real-world environment, such that the user may be immersed in the VR imagery based on computer-generated images.

FIG. 1C illustrates an image perceived by a user of the artificial reality device 100 operating in the AR or MR mode, according to an embodiment of the present disclosure. FIG. 1D illustrates an image perceived by a user of the artificial reality device 100 operating in the VR mode, according to an embodiment of the present disclosure. For discussion purposes, FIGS. 1C and 1D show the images viewed through the right-eye display system 110R. As shown in FIG. 1C, when the artificial reality device 100 operates in the AR or MR mode, the user may perceive a virtual scene or virtual image 102 superimposed with a real-world scene 104. As shown in FIG. 1D, when the artificial reality device 100 operates in the VR mode, the user may perceive the virtual scene 102, but not the real-world scene 104.

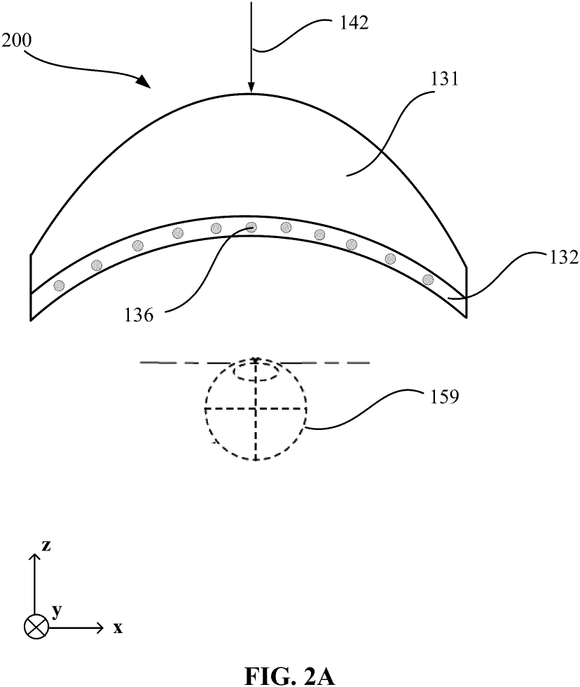

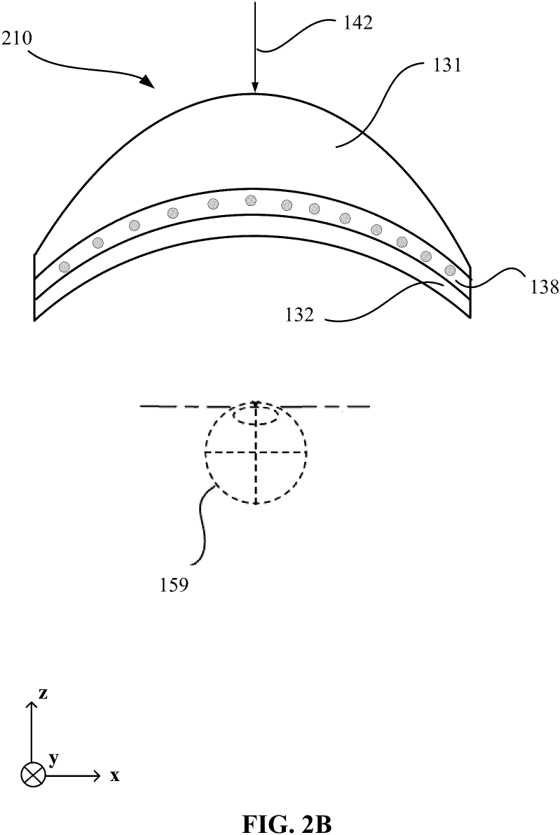

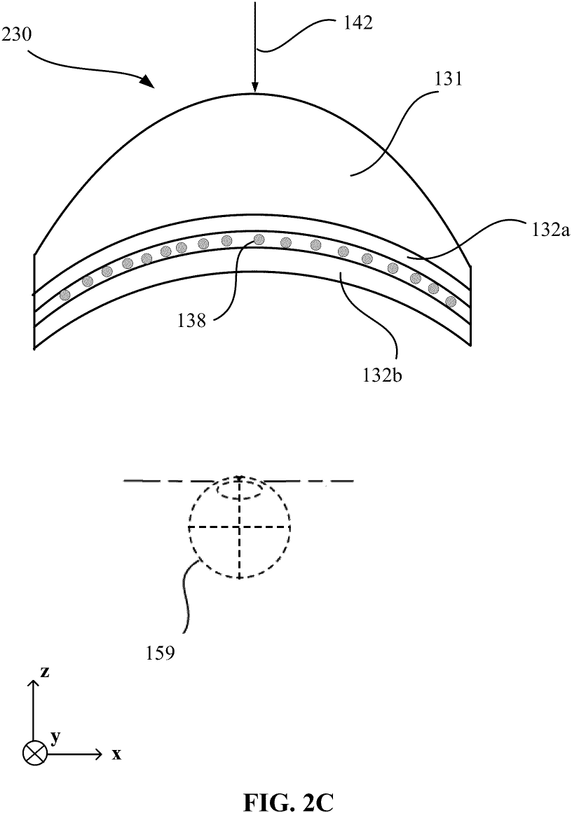

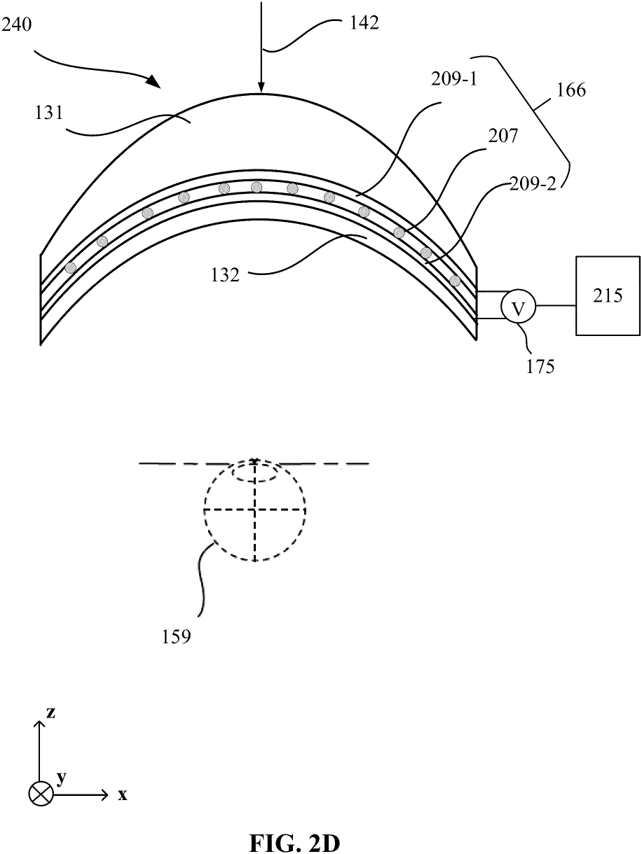

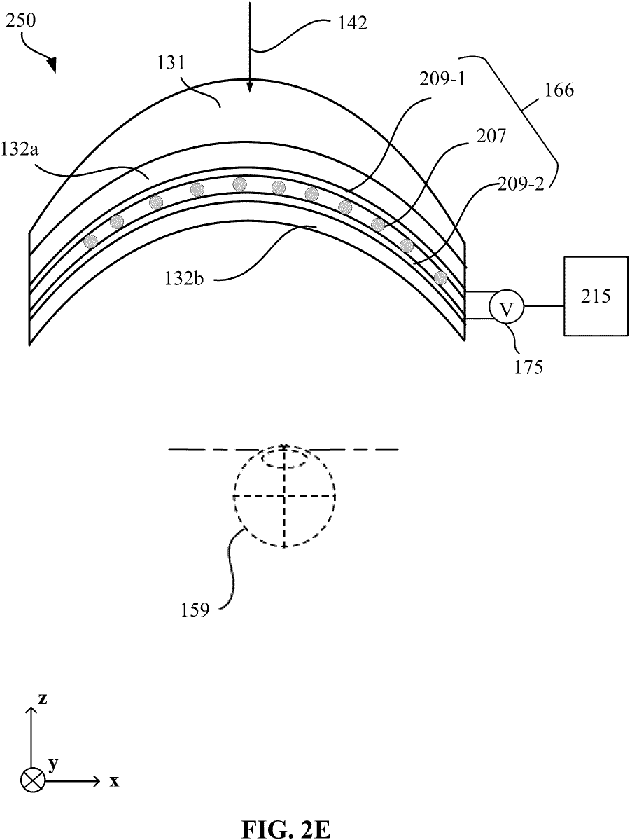

FIG. 2A illustrates a schematic diagram of a dimming lens (or dimming device) 200 according to an embodiment of the present disclosure. The dimming lens 200 may be an embodiment of the dimming lens 122 shown in FIG. 1B. The dimming lens 200 may include a first material layer 131, and a second material layer 132 coupled with the first material layer 131. The first material layer 131 may be at an outer side of the dimming lens 200 facing the real world environment and receiving the ambient light 142. The second material layer 132 may be at an inner side of the dimming lens 200 facing the eye 159 of the user. Although the first material layer 131 and the second material layer 132 are shown as having curved surfaces, in some embodiments, at least one of the first material layer 131 or the second material layer 132 may have one or two flat surfaces in the thickness direction (e.g., the z-axis direction in FIG. 2A).

The first material layer 131 may be fabricated based on a first lens material, and the second material layer 132 may be fabricated based on a second lens material different from the first lens material. In some embodiments, the lens first material and the second lens material may be optically transparent in an operation wavelength range of the dimming lens 200, e.g., the visible spectrum. In some embodiments, the first lens material may have a lower density than the second lens material. In some embodiments, the first lens material may have a lower birefringence than the second lens material across the operation wavelength range of the dimming lens 200, e.g., the visible spectrum. In some embodiments, the first lens material included in the first material layer 131 may have a density that is equal to or less than a predetermined density, and a birefringence that is equal to or less than a predetermined birefringence. Accordingly, the second lens material may have a density that is greater than the predetermined density, and a birefringence that is greater than the predetermined birefringence. For example, the density of the first lens material may be about 1.0 g/cm³ or lower, and the birefringence of the first lens material may be about 10⁻⁵ or lower. That is, the predetermined density may be, for example, 1.0 g/cm³, 1.05 g/cm³, 1.1 g/cm³, etc. The predetermined birefringence may be 10⁻⁵, 2*10⁻⁵, 5*10⁻⁵, etc. The birefringence of the first lens material may be at least 10 times less than the birefringence of the second lens material.

In some embodiments, the second lens material may have a higher impact resistance than the first lens material. Impact resistance (or impact strength) is related to the resistance of a material to impact, and may be measured as the energy (unit: J or ft-lbs) absorbed by a standardized specimen for breaking under a standardized impact. Impact resistance (or impact strength) may be calculated by dividing the impact energy by the thickness of the specimen. In some embodiments, the second lens material may have an impact resistance that is equal to or greater than a predetermined impact resistance threshold. Accordingly, the first lens material may have an impact resistance that is less than the predetermined impact resistance threshold. The impact resistance of the second lens material may be at least 10 times greater than the impact resistance of the first lens material.

For example, the notched impact strength of the second lens material may be about 0.7 ft-lbs/in or higher, about 0.8 ft-lbs/in or higher, about 0.9 ft-lbs/in or higher, about 1.0 ft-lbs/in or higher, about 1.5 ft-lbs/in or higher, about 2.0 ft-lbs/in or higher, about 3.0 ft-lbs/in or higher, about 4.0 ft-lbs/in or higher, about 5.0 ft-lbs/in or higher, about 10.0 ft-lbs/in or higher, about 15.0 ft-lbs/in or higher, etc. The second lens material may meet at least one of the drop-ball test of the Food and Drug Administration (“FDA”) in the United States, or equivalent impact test standards in Europe and Asia for lenses. For example, to pass the FDA’s drop-ball test for lenses, a ⅝-inch steel ball weighing at about 0.56 ounce is dropped from a height of 50 inches to a ⅝-inch diameter circle at the geometric center of the lens, and the lens shall not fracture.

Examples of the first lens material may include cyclic olefin copolymer (“COC”), or cyclic olefin polymer (“COP”), etc. COC and COP have optical properties that are similar to glass, e.g., high transparency, low birefringence, high Abbe number, and high heat resistance. Examples of the second lens material may include polycarbonate (“PC”), polymethyl methacrylate (“PMMA”), polyethylene (“PE”), polyurethane, or polypropylene (“PP”), etc. For example, PC has an impact resistance that is 10 times more than conventional plastic or glass. Below table shows some properties of example materials that may be used as the first lens material and the second lens material. The present disclosure is not limited to these materials.

TABLE

| Material | Density (g/cm³) | Birefringence | Notched impact strength (ft-lbs/in) |
|---|---|---|---|
| COC | 1.0 | Less than 10⁻⁵ | 0.69 |
| COP | 1.08 | Less than 10⁻⁵ | 0.56 |
| PC | 1.20 | ~ 10⁻⁴ | 12.0-16.0 |

In some embodiments, the dimming lens 200 may be an ophthalmic lens with a prescription, e.g., single vision, bifocal, trifocal, or progressive, to provide vision correction to a user’s eyesight. As shown in FIG. 2A, the first material layer 131 may be configured with a customized non-zero optical power for vision correction for a user, and the second material layer 132 may be configured with substantially low or zero optical power (e.g., the second material layer 132 may be a flat slab or a curved slab with uniform thickness and substantially zero optical power). For example, the absolute value of the optical power provided by the second material layer 132 may be lower than the absolute value of the optical power provided by the first material layer 131. The radius of curvature of the inner surface of the first material layer 131 may be substantially the same as the radius of curvature of the outer surface of the second material layer 132. For discussion purposes, FIG. 2A shows that the first material layer 131 functions as a concavo-convex lens configured for far-sightedness correction. In some embodiments, the first material layer 131 may be configured for another type of vision correction, e.g., the first material layer 131 may function as a convexo-concave lens configured for near-sightedness correction, etc. In some embodiments, the dimming lens 200 may not provide a vision correction, and each of the first material layer 131 and the second material layer 132 may be configured with zero optical power, e.g., each of the first material layer 131 and the second material layer 132 may be a flat slab or a curved slab with zero optical power.

The first material layer 131 fabricated based on the first lens material with relatively low density and low birefringence may have light weight and good image quality. In addition, the second material layer 132 fabricated based on the second lens material with relatively high impact resistance may provide a good safety for the eye 159 of the user. When the second material layer 132 is configured with zero optical power, the relatively high birefringence of the second lens material included in the second material layer 132 may not degrade the image performance of the dimming lens 200.

In some embodiments, the first material layer 131 may be configured to be thicker than the second material layer 132. For example, the thickness of the first material layer 131 may be in a range of 0.1 mm to 1.1 mm, a range of 0.1 mm to 1.0 mm, a range of 0.1 mm to 0.9 mm, a range of 0.1 mm to 0.8 mm, a range of 0.1 mm to 0.7 mm, a range of 0.1 mm to 0.6 mm, a range of 0.1 mm to 0.5 mm, a range of 0.5 mm to 1.1 mm, a range of 0.6 mm to 1.1 mm, a range of 0.7 mm to 1.1 mm, or a range of 0.8 mm to 1.1 mm, etc. In some embodiments, the thickness of the second material layer 132 may be in a range of 0.01 mm to 0.5 mm, a range of 0.01 mm to 0.4 mm, a range of 0.01 mm to 0.3 mm, a range of 0.01 mm to 0.2 mm, or a range of 0.01 mm to 0.1 mm, etc. In some embodiments, a center thickness of the first material layer 131 may be in a range of 1.0 mm to 1.5 mm. The “center thickness” may be a thickness measured at a geometric center point (which may also be an optical center point) of the layer. In some embodiments, the center thickness of the second material layer 132 may be in a range of 0.2 mm to 0.7 mm. In some embodiments, the first material layer 131 may have a retardance value that is less than 100 nm in the operation wavelength range, e.g. the visible wavelength range.

In some embodiments, the first material layer 131 and the second material layer 132 may be fabricated via suitable processes, such as diamond turning, molding, casting, three-dimensional (“3D”) printing, or a combination thereof. In some embodiments, the first material layer 131 and the second material layer 132 may be laminated together (e.g., via an optically clear adhesive layer), with the second material layer 132 laminated onto an inner side (e.g., a concave surface) of the first material layer 131 that faces the eye 159 of the user. For example, the first material layer 131 and the second material layer 132 may be laminated and bonded together through a suitable optically clear adhesive. In some embodiments, the optically clear adhesive layer may have a uniform thickness across an aperture of the dimming lens 200. The thickness of the optically clear adhesive layer may be in a range of 0.01 mm to 0.2 mm. The dimming lens 200 may include a dimming material 136 for dimming the ambient light 142, and the dimming material 136 may be doped into at least one of the first material layer 131 or the second material layer 132. For illustrative purposes, FIG. 2A shows that the dimming material 136 is doped into the second material layer 132. In some embodiments, although not shown, the dimming material 136 may be doped into the first material layer 131. The dimming material 136 may include a non-electrically tunable dimming material, such as a photochromic material, a photodichroic material, a thermochromic material, etc. The dimming material 136 may provide a tunable dimming effect (e.g., in accordance with temperature or brightness of the ambient light 142), or may provide a non-tunable, fixed dimming effect to the ambient light 142.

A conventional lens fabricated based on a single first lens material layer (e.g., COC, or COP, etc.) may provide a relatively light weight and a relatively low birefringence but a relatively low impact resistance, while a conventional lens fabricated based on a single second lens material layer (e.g., PC, PMMA, PE, or PP, etc.) may provide a relatively high impact resistance but a relatively heavy weight and a relatively high birefringence. The dimming lens 200 including the first material layer 131 fabricated on the first lens material and the second material layer 132 fabricated on the second lens material may be configured to provide a balance between the weight, the birefringence, and the impact resistance. For example, compared to the conventional lens fabricated based on the single first lens material layer (e.g., COC, or COP, etc.) or the single second lens material layer (e.g., PC, PMMA, PE, or PP, etc.), the dimming lens 200 may provide a low weight, a low birefringence, and a high impact resistance at the same time.

FIG. 2B illustrates a schematic diagram of a dimming lens (or dimming device) 210 according to an embodiment of the present disclosure. The dimming lens 210 may be an embodiment of the dimming lens 122 shown in FIG. 1B. The dimming lens 210 may include the first material layer 131 fabricated based on the first lens material, and the second material layer 132 fabricated based on the second lens material. In the embodiment shown in FIG. 2B, the dimming lens 210 may also include a dimming material layer 138 disposed between the first material layer 131 and the second material layer 132. In some embodiments, the dimming material layer 138 may include a non-electrically tunable dimming material, such as a photochromic material, a photodichroic material, a thermochromic material, etc. The dimming material layer 138 may provide a tunable dimming effect (e.g., in accordance with temperature or brightness of the ambient light 142), or a non-tunable, fixed dimming effect to the ambient light 142.

FIG. 2C illustrates a schematic diagram of a dimming lens (or dimming device) 230 according to an embodiment of the present disclosure. The dimming lens 230 may be an embodiment of the dimming lens 122 shown in FIG. 1B. The dimming lens 230 may include the first material layer 131 fabricated based on the first lens material, two second material layers 132a and 132b (which may be referred to as a second material layer and a third material layer, respectively) fabricated based on the second lens material, and the dimming material layer 138. A stack formed by the dimming material layer 138 and the second material layers 132a and 132b may be disposed at an inner side of the first material layer 131 that faces the eye 159. For example, the stack formed by the dimming material layer 138 and the second material layers 132a and 132b may be laminated to the inner side (e.g., a concave surface) of the first material layer 131 that faces the eye 159 of the user. The second material layer 132a may be disposed between the first material layer 131 and the dimming material layer 138. The dimming material layer 138 may be disposed between the second material layers 132a and 132b. The first material layer 131 may be configured with a non-zero optical power for vision correction, and the second material layers 132a and 132b may be configured with substantially low or zero optical power (e.g., the second material layer 132a or 132b may be a flat slab or a curved slab with uniform thickness and substantially zero optical power). For example, the absolute value of the optical power provided by the second material layers 132a and 132b may be lower than the absolute value of the optical power provided by the first material layer 131.

FIG. 2D illustrates a schematic diagram of a dimming lens (or dimming device) 240 according to an embodiment of the present disclosure. The dimming lens 240 may be an embodiment of the dimming lens 122 shown in FIG. 1B. The dimming lens 240 may include the first material layer 131, the second material layer 132, and a dimming cell (or dimming element) 166 disposed between the first material layer 131 and the second material layer 132. The dimming cell 166 may include a dimming material layer 207 and at least one electrode layer. For illustrative purposes, FIG. 2D shows that a first electrode layer 209-1 and a second electrode layer 209-2 are disposed at opposite sides of the dimming material layer 207, respectively. The electrode layers 209-1 and 209-2 may be optically transparent in the operation wavelength range of the dimming lens 240, e.g., the visible spectrum. In some embodiments, the electrode layers 209-1 and 209-2 may also be optically transparent in the IR spectrum.

In some embodiments, each of the electrode layers 209-1 and 209-2 may include a continuous planar electrode. In some embodiments, one of the electrode layers 209-1 and 209-2 may include a continuous planar electrode, and the other one of the electrode layers 209-1 and 209-2 may include a patterned electrode formed by a plurality of discrete, separated sub-electrodes. For example, in some embodiments, the patterned electrode may include a first sub-electrode that is surrounded by a second sub-electrode. In some embodiments, the patterned electrode may include an array of pixelated sub-electrodes. In some embodiments, each of the electrode layers 209-1 and 209-2 may include a patterned electrode. For example, in some embodiments, each patterned electrode may include a plurality of separate, striped electrodes arranged in parallel, and the striped electrodes in the respective patterned electrodes may be arranged to extend in parallel in different directions, e.g., orthogonal directions. In some embodiments, the electrode layers 209-1 and 209-2 may include a conductive material of indium tin oxide (“ITO”), Al-doped zinc oxide (“AZO”), graphene, poly(3,4-ethylenedioxythiophene): poly(styrene-sulfonate) (“PEDOT:PSS”), carbon nanotubes, or silver nanowires, or a combination thereof.

In some embodiments, the two electrode layers 209-1 and 209-2 may be disposed at the inner surface of the first material layer 131 and the outer surface of the second material layer 132 via a suitable approach (e.g., coating, or deposition, etc.), respectively. In some embodiments, to reduce the surface reflection at an interface between the electrode layer 209-1 and the inner surface of the first material layer 131, an index-matching layer (not shown) may be disposed between the electrode layer 209-1 and the inner surface of the first material layer 131. In some embodiments, to reduce the surface reflection at an interface between the electrode layer 209-2 and the outer surface of the second material layer 132, an index-matching layer (not shown) may be disposed between the electrode layer 209-2 and the outer surface of the second material layer 132.

The dimming material layer 207 may include a dimming material having an electrically tunable transmittance (referred to as an electrically tunable dimming material for discussion purposes). The light transmittance of the electrically tunable dimming material may be tunable when an electric field applied to the dimming material is varied, as controlled by a controller. Examples of the electrically tunable dimming material may include a guest-host liquid crystal (“LC”) material (e.g., a host LC doped with guest dyes (e.g., dichroic dyes)), a polymer stabilized cholesteric LC material, suspended particles, an electrochromic material, an electrophoretic material, etc. In some embodiments, the dimming material layer 207 may also include a dimming material having a non-electrically tunable transmittance (referred to as a non-electrically tunable dimming material for discussion purposes). The light transmittance of the non-electrically tunable dimming material may be tunable via an approach other than turning a voltage, e.g., by changes in an ambient light, or a temperature, etc. Examples of the non-electrically tunable dimming material may include a photochromic material, a photodichroic material, a thermochromic material, etc. Examples of the dimming device 166 may include a guest-host liquid crystal (“LC”) dimming device, a polymer stabilized cholesteric LC dimming device, a suspended particle device, an electrochromic dimming device, an electrophoretic dimming device, an electroplating dimming device, a photochromic dimming device, a photodichroic dimming device, a dimming device including an electrically-tunable dimming material layer and a non-electrically tunable dimming material layer, etc.

In some embodiments, the dimming material layer 207 may be configured with a uniform thickness across an aperture of the dimming device 166 (e.g., in the x-axis direction in FIG. 2D). In some embodiments, the dimming material layer 207 may be configured with a nonuniform thickness across the aperture of the dimming device 166. For example, the dimming material layer 207 may have a greater thickness at the center of the aperture than at the periphery of the aperture. For discussion purposes, FIG. 2D shows that the dimming material layer 207 is configured with two curved surfaces, and the electrode layers 209-1 and 209-2 are curved electrode layers. In some embodiments, the dimming material layer 207 may be configured with a curved surface and a flat surface, e.g., one of the electrode layers 209-1 and 209-2 may be a curved electrode layer and the other may be a flat electrode layer. In some embodiments, the dimming material layer 207 may be configured with two flat surfaces, e.g., each of the electrode layers 209-1 and 209-2 may be a flat electrode layer.

The electrode layers 209-1 and 209-2 may be electrically coupled with a power source 175. A controller 215 may be connected with the power source 175, and may control the output (e.g., voltage output or current output) of the power source 175 to the electrode layers 209-1 and 209-2. Accordingly, the controller 215 may control the electric field (e.g., an amplitude of and/or a direction of the electric field) applied to the dimming material layer 207 via the electrode layers 209-1 and 209-2, thereby controlling the operation state of the dimming device 166. In some embodiments, the controller 215 may control the dimming device 166, such that the dimming device 166 is switchable between operating in a clear state and a dark state (also referred to as an opaque state). Accordingly, the dimming lens 240 may be switchable between operating in the clear state and the dark state.

In some embodiments, the dimming device 166 operating in the dark state may be configured to substantially block the visible real-world light 142, e.g., with a light transmittance of about 0.01% (or with an optical density of 4.0). The light transmittance of the dimming device 166 operating in the dark state may be referred to as a minimum transmittance of the dimming device 166. The dimming device 166 operating in the clear state may be configured to provide a predetermined transmittance that is greater than the minimum transmittance to the real-world light 142. In some embodiments, the predetermined transmittance may be within a range from about 30% to about 50%, e.g., 30%, 35%, 40%, 45%, 50%, 30%-40%, 40%-50%, or any other sub-range within the range of 30%-50%. In some embodiments, the predetermined transmittance may be within a range from about 30% to about 60% (e.g., 30%, 35%, 40%, 45%, 50%, 55%, 60%, 30%-40%, 40%-50%, 50%-60%, or any other sub-range within the range of 30%-60%), a range from about 30% to about 70% (e.g., 30%, 35%, 40%, 45%, 50%, 55%, 60%, 65%, 70%, 30%-40%, 40%-50%, 50%-60%, 60%-70%, or any other sub-range within the range of 30%-70%), a range from about 30% to about 80% (e.g., 30%, 35%, 40%, 45%, 50%, 55%, 60%, 65%, 70%, 75%, 80%, 30%-40%, 40%-50%, 50%-60%, 60%-70%, 70%-80%, or any other sub-range within the range of 30%-80%), or a range from about 30% to about 90% (30%, 35%, 40%, 45%, 50%, 55%, 60%, 65%, 70%, 75%, 80%, 85%, 90%, 30%-40%, 40%-50%, 50%-60%, 60%-70%, 70%-80%, 80%-90%, or any other sub-range within the range of 30%-90%), etc. Thus, the user may perceive a virtual scene superimposed with a real-world scene. For discussion purposes, the predetermined transmittance of the dimming device 166 operating in the clear state may be referred to as a maximum transmittance of the dimming device 166. In some embodiments, the controller 215 may also control the dimming device 166 to operate in an intermediate state, in addition to the clear state and the dark state. Accordingly, the dimming lens 240 may operate in the intermediate state. The dimming device 166 operating in the intermediate state may provide a transmittance that is greater than the minimum transmittance at the dark state, and less than the maximum transmittance at the clear state. Through controlling the transmittance of the dimming device 166, the transmittance of the dimming lens 240 may be controlled. Accordingly, the transmittance of the see-through view observed through the dimming lens 240 may be dynamically adjusted.

In some embodiments, the dimming device 166 may be a global dimming device configured with a light transmittance that is uniform over the entire aperture of the dimming device 166. In other words, the dimming device 166 may be configured to uniformly dim or attenuate the real-world light 142 over the entire aperture of the dimming device 166. Accordingly, the dimming lens 240 may be a global dimming lens. In some embodiments, the dimming device 166 may be a regional or local dimming device configured to provide different light transmittances at different regions (or areas) of the aperture of the dimming device 166. The light transmittances at the respective regions or portions for the real-world light 142 may be individually or independently controllable. In some embodiments, each region (or area) of the aperture of the dimming device 166 may include one more pixelated dimming elements. The light transmittances at the respective pixelated dimming elements may be individually or independently controllable. In some embodiments, the size of the respective pixelated dimming element may be greater than 1 millimeter. Accordingly, the dimming lens 240 may be a regional or local dimming lens.

For illustrative purposes, the dimming effect of the dimming lens 240 shown in FIG. 2D is shown as being tunable through an external electric field applied to the dimming material layer 207. Other mechanism may also be implemented to adjust the dimming effect, based on the properties of the dimming material.

FIG. 2E schematically illustrates a diagram of a dimming lens 250, according to an embodiment of the present disclosure. The dimming lens 250 may include the first material layer 131, the dimming cell 166, and two second material layers 132a and 132b. The dimming cell 166 may be disposed between the two second material layers 132a and 132b. For example, the dimming cell 166 may be encapsulated into the second lens material, such that substantially the entire dimming cell 166 is surround by the second lens material. The materials included in the two second material layers 132a and 132b may be substantially the same as the second lens material included in the second material layer 132, as described above. The configuration may be similar to that shown in FIG. 2C, except that the dimming effect is provided by the electrically tunable dimming cell 166.

In various embodiments shown in FIG. 2D and FIG. 2E, in addition to the electrically tunable dimming cell 166, the dimming lens 240 or 250 may also include a separate, non-electrically tunable dimming material layer provided at a suitable location, such as the outer surface of the first material layer 131, between the first material layer 131 and the active dimming cell 166 in the embodiment shown in FIG. 2D, or between the first material layer 131 and the second material layer 132a in the embodiment shown in FIG. 2E. In some embodiments, the dimming material layer 138 shown in FIG. 2C may also be replaced by the electrically tunable dimming cell 166.

Referring to FIGS. 2A-2E, in some embodiments, the dimming lens 200, 210, 230, 240, or 250 may be a global dimming lens configured with a light transmittance that is uniform over the entire aperture of the dimming lens. In other words, the dimming lens 200, 210, 230, 240, or 250 may be configured to uniformly dim or attenuate the real-world light 142 over the entire aperture of the dimming lens. In some embodiments, the dimming lens 200, 210, 230, 240, or 250 may be a regional or local dimming lens configured to provide different light transmittances at different regions (or areas) of the aperture of the dimming lens. The light transmittances at the respective regions or portions of the dimming lens for the real-world light 142 may be individually or independently controllable. In some embodiments, each region (or area) of the aperture of the dimming lens may include one more pixelated dimming elements. The light transmittances at the respective pixelated dimming elements may be individually or independently controllable.

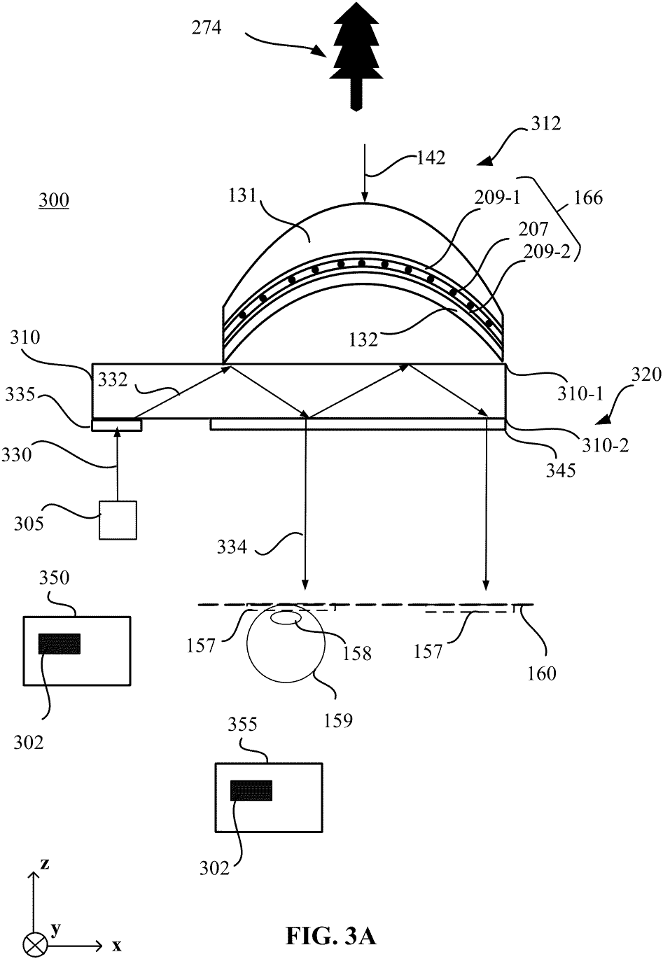

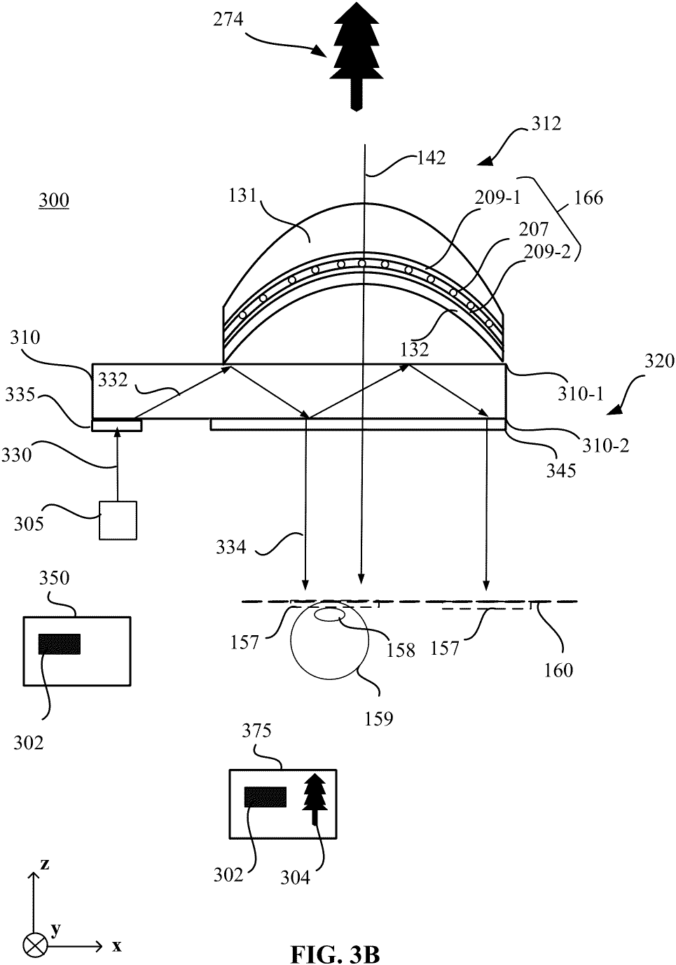

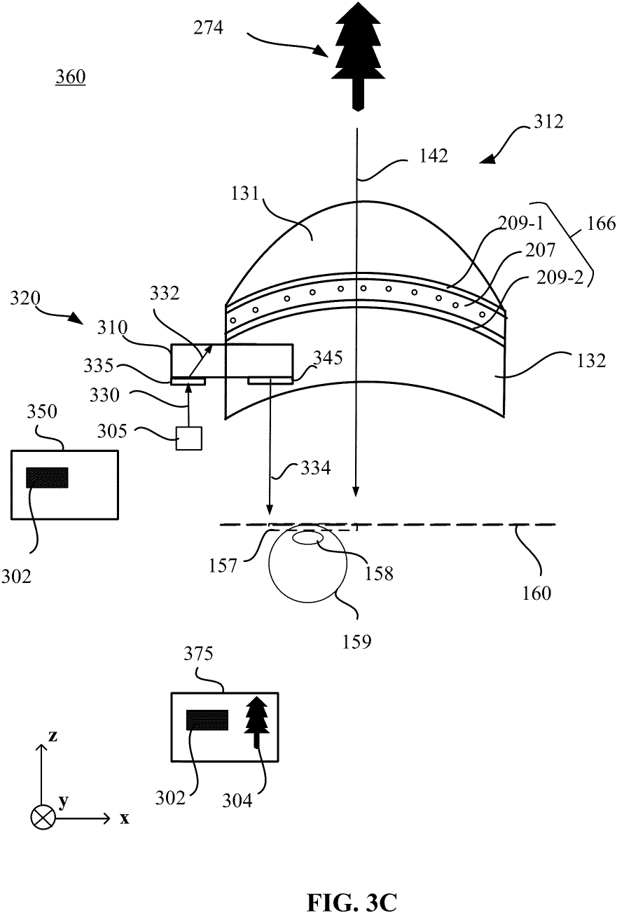

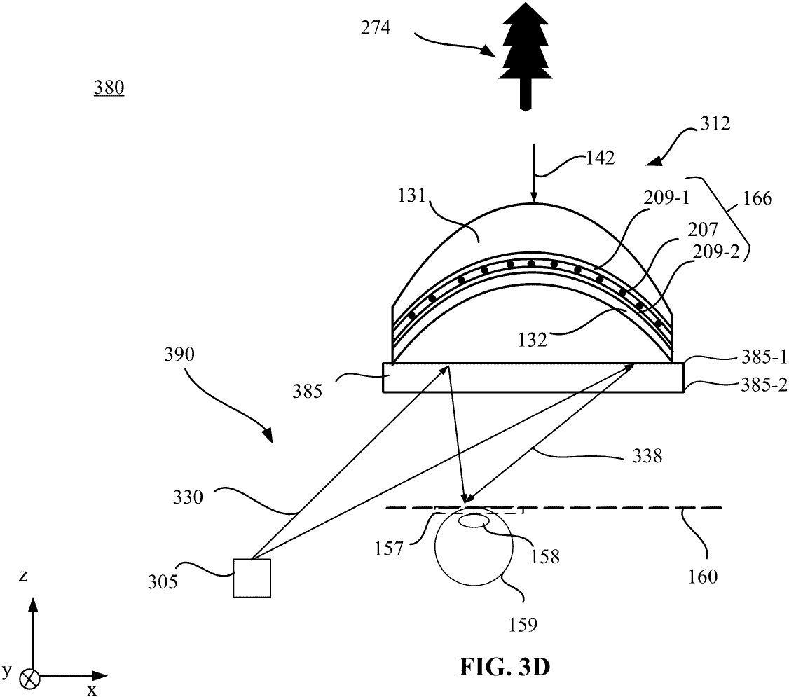

FIG. 3A illustrates an x-z sectional view of a display system 300, according to an embodiment of the present disclosure. The display system 300 may be implemented in an artificial reality device for AR, VR, and/or MR applications, such as the artificial reality device 100 shown in FIGS. 1A-1D. For example, the display system 300 may be an embodiment of the display system 110L or 110R shown in FIGS. 1A and 1B. As shown in FIG. 3A, the display system 300 may include a light guide display assembly 320. The light guide display assembly 320 may be included in or implemented as the image display assembly 120 shown in FIG. 1B. The display system 300 may also include a dimming lens 312. The dimming lens 312 may be any embodiment of the dimming lenses disclosed herein such as the dimming lens 200 shown in FIG. 2A, the dimming lens 210 shown in FIG. 2B, the dimming lens 230 shown in FIG. 2C, the dimming lens 240 shown in FIG. 2D, or the dimming lens 250 shown in FIG. 2E. For discussion purposes, FIG. 3A shows that the dimming lens 312 has a configuration that is the same as or similar to the dimming lens 240 shown in FIG. 2D.

The dimming lens 312 may be provided at an outer side of the light guide display assembly 320 that faces the real world environment. The light guide display assembly 320 may include a light source assembly 305. The light guide 310 may be coupled with an in-coupling element 335 and an out-coupling element 345. The light guide 310 may include a first surface 310-1 and a second surface 310-2. The light source assembly 305 may be configured to output an image light 330 representing a virtual image 350 (e.g., including a virtual object 302). The light guide 310 coupled with the in-coupling element 335 and the out-coupling element 345 may be configured to guide the image light 330 to one or more exit pupils 157 in the eye-box region 160 of the display system 300. For example, the in-coupling element 335 may couple the image light 330 into the light guide 310 as an in-coupled image light 332. The in-coupled image light 332 may propagate inside the light guide 310 through total internal reflection, from the in-coupling element 335 toward the out-coupling element 345. The out-coupling element 345 may couple the in-coupled image light 332 incident onto different portions of the out-coupling element 345 out of the light guide 310 as a plurality of output image lights 334 propagating toward the eye-box region 160, thereby replicating the image light 330 at the outside of the light guide 320. Thus, the eye 159 located at the exit pupil 157 may perceive the virtual image generated by the light source assembly 305. In some embodiments, the light guide 310 coupled with the in-coupling element 335 and the out-coupling element 345 may also transmit the real-world light 142 toward the eye-box region 160. Thus, the eye 159 located at the exit pupil 157 may perceive the virtual image optically combined with the real-world scene. The light guide 310 coupled with the in-coupling element 335 and the out-coupling element 345 may function as an image combiner that optically combines the virtual scene with the real-world scene, e.g., a light guide image combiner.

In some embodiments, the dimming lens 312 may be separately formed and disposed at (e.g., affixed to) a surface of the light guide 310 facing the real-world environment (e.g., the first surface 310-1). In some embodiments, the first dimming lens 312 may be integrally formed as a part of the light guide 310. In some embodiments, an area of the dimming lens 312 may be greater than or equal to an area of the out-coupling element 345. The dimming lens 312 may be disposed at a side of the out-coupling element 345 that is facing the real world environment. In some embodiments, as shown in FIG. 3A, the dimming lens 312 may be disposed at the first surface 310-1 of the light guide 310, and the out-coupling element 345 may be disposed at the second surface 310-2 of the light guide 310. In some embodiments, the out-coupling element 345 may also be disposed at the first surface 310-1, between the dimming lens 312 and the light guide 310. It is noted that although the light guide 310 is shown as having flat surfaces in FIG. 3A, the light guide 310 may have a curved surface, or the entire light guide 310 may be curved (e.g., having a curvature that matches the curvature of the second material layer 132).

The controller 215 (not shown) may be communicatively coupled with the various elements in the dimming lens 312 and/or the light guide display assembly 320 to control the operation thereof. The controller 215 may control the operation state of the dimming lens 312 to dynamically adjust the transmittance of the real-world light 142, thereby switching an artificial reality device including the display system 300 between operating in the VR mode and operating in the AR device, or between operating in the VR device and operating in the MR device. For example, when the controller 215 controls the dimming lens 312 to operate in the dark state, the artificial reality device including the display system 300 may be configured to operate in the VR mode. When the controller 215 controls the dimming lens 312 to operate in the clear state or intermediate state, the artificial reality device including the display system 300 may be configured to operate in the AR mode or MR mode. In some embodiments, the dimming lens 312 may be configured to dynamically attenuate the real-world light 142 depending on the brightness of the real-world environment, thereby adjusting the brightness of the see-through view. For example, when the artificial reality device including the display system 300 operates in the AR mode or MR mode, the dimming lens 312 may be configured to adjust the brightness of the see-through view to mitigate the brightness difference between the see-through view and the virtual image that are perceived by the user.

In some embodiments, the dimming lens 312 may be a global dimmer. For example, when the artificial reality device including the display system 300 operates in the AR mode or MR mode, the display system 300 may provide a uniform contrast ratio of the see-through view and the virtual image over the aperture of the dimming lens 312. In some embodiments, the dimming lens 312 may be a regional or local dimmer. For example, when the artificial reality device including the display system 300 operates in the AR mode or MR mode, the display system 300 may provide different contrast ratios of the see-through view and the virtual image at different regions (or portions, areas) of the aperture of the dimming lens 312.

For discussion purposes, FIG. 3A shows that the controller 215 controls the dimming lens 312 to operate in the dark state and, thus, the artificial reality device including the display system 300 operates in the VR mode. The dimming lens 312 may substantially block the real-world light 142 from being transmitted through the light guide 310 toward the eye-box region 160. Thus, the eye 159 located at the exit-pupil 157 may perceive an image 355 of the virtual object 302 only.

For discussion purposes, FIG. 3B shows that the controller 215 controls the dimming lens 312 to operate in the clear state or the intermediate state and, thus, the artificial reality device including the display system 300 operates in the AR mode or MR mode. The dimming lens 312 may transmit the real-world light 142 toward one or more exit pupils 157 in the eye-box region 160. Thus, the eye 159 located at the exit-pupil 157 may perceive an image 375, in which a virtual scene (e.g., the virtual object 302) is superimposed with a real-world scene (e.g., an image 304 of a real-world object 274). In some embodiments, the dimming lens 312 may be an ophthalmic lens configured to alter the real-world light 142 to provide vision correction to the user’s eyesight, while transmitting the real-world light 142.

FIGS. 3A and 3B show that the light guide display assembly 320 and the dimming lens 312 are individual components that are arranged in a stacked configuration. In some embodiments, the light guide display assembly 320 may be embedded in the dimming lens 312. FIG. 3C illustrates an x-z sectional view of a display system 360, according to an embodiment of the present disclosure. The display system 360 may be implemented in an artificial reality device for AR, VR, and/or MR applications, such as the artificial reality device 100 shown in FIGS. 1A-1D. For example, the display system 360 may be an embodiment of the display system 110L or 110R shown in FIGS. 1A and 1B. The display system 360 may include elements, structures, and/or functions that are the same as or similar to those included in the display system 300 shown in FIGS. 3A and 3B. Descriptions of the same or similar elements, structures, and/or functions can refer to the above descriptions rendered in connection with FIGS. 3A and 3B.

As shown in FIG. 3C, the display system 360 may include the light guide display assembly 320 and the dimming lens 312. In the embodiment shown in FIG. 3C, the light guide display assembly 320 and the dimming lens 312 may not be arranged in a stacked configuration. Instead, the light guide display assembly 320 may be at least partially embedded in the second material layer 132 of the dimming lens 312. The light guide display assembly 320 may not be embedded in the dimming device 166 and the first material layer 131 and, thus, the output image light 334 of the light guide 310 may not be affected by the dimming device 166. In some embodiments, the second material layer 132 of the dimming lens 312 may alter the output image light 334 to provide vision correction to the user’s eyesight, while transmitting the output image light 334 toward one or more exit pupils 157 in the eye-box region 160. In some embodiments, although not shown, the dimming lens 312 may include a non-electrically tunable dimming material doped into the first material layer 131, and the light guide display assembly 320 may be at least partially embedded in the second material layer 132 of the dimming lens 312. As shown in FIG. 3C, in some embodiments, at least a portion of the light guide 310 where the out-coupling element 345 is mounted may be embedded in the second material layer 132 of the dimming lens 312. In some embodiments, the light guide 310 may be a curved light guide having a curvature that matches the curvature of the second material layer 132.

FIG. 3D illustrates an x-z sectional view of a display system 380, according to an embodiment of the present disclosure. The display system 380 may be implemented in an artificial reality device for AR, VR, and/or MR applications, such as the artificial reality device 100 shown in FIGS. 1A-1D. For example, the display system 380 may be an embodiment of the display system 110L or 110R shown in FIGS. 1A and 1B. The display system 380 may include elements, structures, and/or functions that are the same as or similar to those included in the display system 300 shown in FIGS. 3A and 3B, or the display system 360 shown in FIG. 3C. Descriptions of the same or similar elements, structures, and/or functions can refer to the above descriptions rendered in connection with FIGS. 3A and 3B or FIG. 3C.

As shown in FIG. 3D, the display system 380 may include a holographic optical element (“HOE”) display assembly 390 and the dimming lens 312. The HOE display assembly 390 may include the light source assembly 305 and an HOE image combiner 385. The light source assembly 305 may be configured to output the image light 330 representing a virtual image 350 (e.g., including the virtual object 302) toward the HOE image combiner 385. The HOE image combiner 385 may focus the image light 330 to one or more spots at one or more exit pupils 157 within the eye-box region 160. In some embodiments, the dimming lens 312 may be separately formed and disposed at (e.g., affixed to) a surface of the HOE image combiner 385 facing the real-world environment (e.g., a first surface 385-1). It is noted that although the HOE image combiner 385 is shown as having flat surfaces in FIG. 3D, the HOE image combiner 385 may have a curved surface, or the entire HOE image combiner 385 may be curved (e.g., having a curvature that matches the curvature of the second material layer 132).

The controller 215 (not shown) may be communicatively coupled with the various elements in the dimming lens 312 and/or the HOE display assembly 390 to control the operation thereof. For example, the controller 215 may control the operation state of the dimming lens 312 to dynamically adjust the transmittance of the real-world light 142, thereby switching an artificial reality device including the display system 380 between operating in the VR mode and operating in the AR device, or between operating in the VR device and operating in the MR device. When configured for AR or MR applications, the HOE image combiner 385 may combine an image light 338 focused by the HOE image combiner 385 and the real-world light 142, and direct both lights toward the eye-box region 160.

In some embodiments, although not shown, the HOE image combiner 385 may be at least partially embedded in the second material layer 132 of the dimming lens 312. The HOE image combiner 385 may not be embedded in the dimming device 166 and the first material layer 131 and, thus, the output image light 338 of the HOE image combiner 385 may not be affected by the dimming device 166.

The display system 300 shown in FIGS. 3A and 3B, the display system 360 shown in FIG. 3C, and the display system 380 shown in FIG. 3D are for illustrative purposes to explain the implementation of a disclosed dimming lens into a display system included in an artificial reality device. The disclosed dimming lens may also be implemented in smart glasses, or other suitable eyewear. The light guide display assembly 320 shown in FIGS. 3A-3C and the HOE display assembly 390 are for illustrative purposes, and are examples of the image display assembly 120 shown in FIG. 1B. In some embodiments, the display system may include another suitable image display assembly other than the light guide display assembly 320 and the HOE display assembly 390, and the display assembly may include another suitable image combiner other than the light guide image combiner and the HOE image combiner.

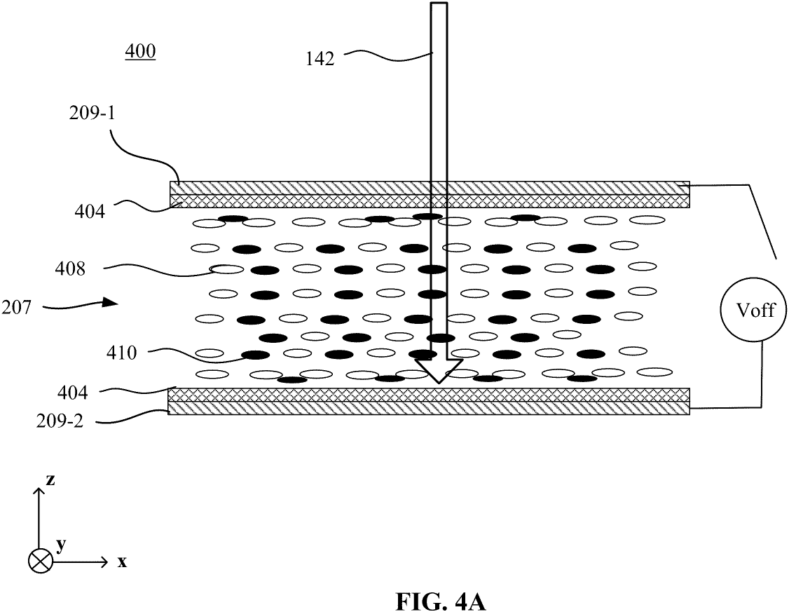

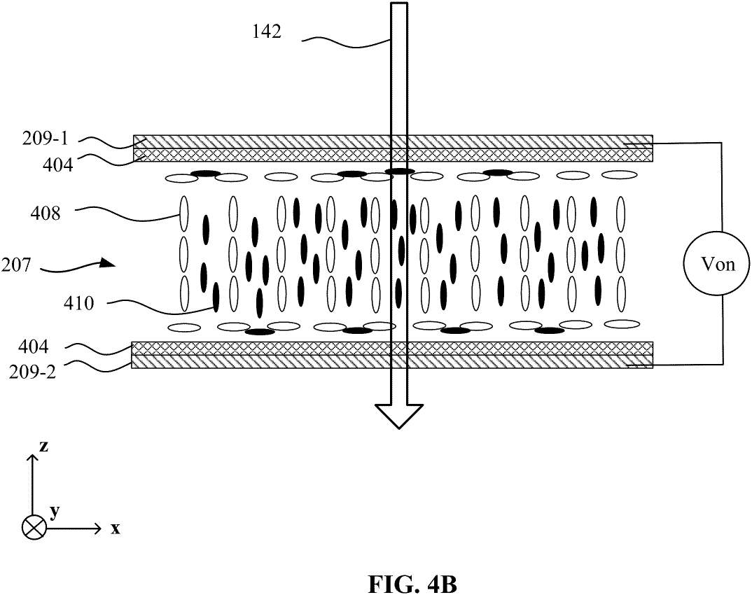

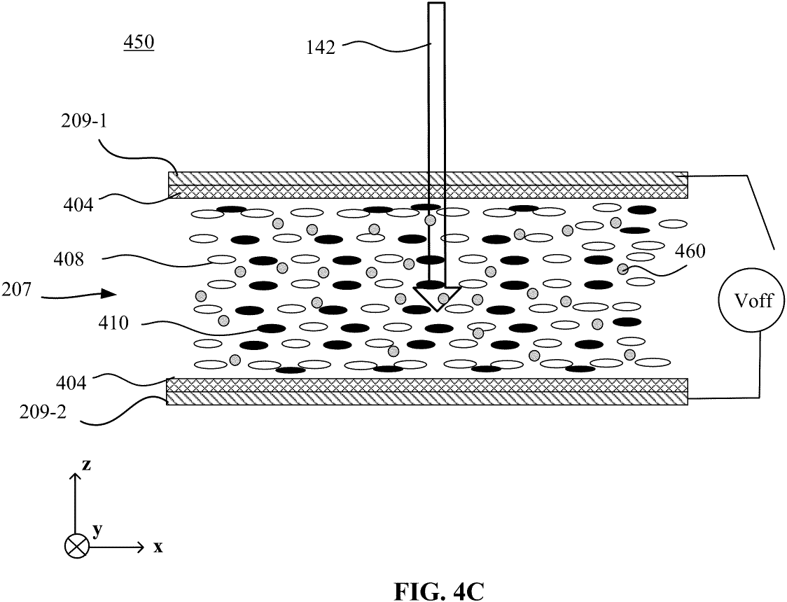

In the following, exemplary dimming elements that may be implemented in the disclosed dimming lens will be explained. The dimming element may attenuate an input light via a suitable dimming mechanisms, such as polarization, absorption, and/or scattering, etc. FIGS. 4A and 4B illustrate x-z sectional views of a dimming element 400, according to an embodiment of the disclosure. The dimming element 400 may be an embodiment of the dimming element 166 show in FIG. 2D or FIG. 2E. The dimming element 400 may be a guest-host type LC dimming device. As shown in FIG. 4A, the dimming element 400 may include electrode layers (or electric conduction layers) 209-1 and 209-2, and the dimming material layer 207 disposed between the electrode layers 209-1 and 209-2. Each electrode layer 209-1 or 209-2 may be provided with an alignment layer 404. The dimming material layer 207 may be disposed between the alignment layers 404. The alignment layers 404 provide alignments to the molecules included in the dimming material layer 207. In the embodiment shown in FIGS. 4A and 4B, the dimming material layer 207 may be a guest-host LC layer that includes a mixture of host LCs 408 and guest dyes 410 doped into the LCs 408. In the embodiment shown in FIG. 4A, the guest dyes 410 may include dichroic dyes (also referred to as 410 for discussion purposes) that are voltage-responsive or electric-field-responsive dyes, and the guest-host LC layer may be a voltage-driven guest-host LC layer.

The dichroic dyes 410 may be organic molecules having an anisotropic absorption. The absorption properties of the dichroic dyes 410 may depend on a relative orientation between an absorption axis of the dichroic dyes 410 (e.g., long axis or short axis of the dye molecules) and a polarization direction of an incident light. For example, the dichroic dyes 410 may relatively strongly absorb an incident light having a polarization direction that is parallel to an absorption axis (e.g., long axis or short axis) of the dye molecules, and relatively weakly absorb the incident light having a polarization direction that is perpendicular to the absorption axis (e.g., long axis or short axis) of the dye molecules. That is, the dichroic dyes 410 may provide a greater dimming effect to an incident light having a polarization direction parallel to the absorption axis of the dye molecules than to an incident light having a polarization direction perpendicular to the absorption axis. Thus, through varying the orientation of the dye molecules via, e.g., an electric field, the transmittance of the incident light 142 may be adjusted.

The LCs 408 in the dimming material layer 207 may have positive or negative dielectric anisotropy. For illustrative purposes, FIGS. 4A and 4B show that the LCs 408 have positive dielectric anisotropy (Δε >0). The dye molecules of the dichroic dye 410 may be aligned together with the LC molecules 408 in an x-axis direction at a voltage-off state. As shown in FIGS. 4A and 4B, when the directors of the LCs 408 change from a planar orientation to a perpendicular orientation along with an applied voltage V, the long molecular axis of the dye molecules may also change the orientation along with the LCs 408. In other words, the dye molecules may change from a planar orientation (a strong absorption state) at V=0 to a perpendicular orientation (a weak absorption state) at V≠0. Accordingly, the dimming element 400 may be switched from operating at a dark state at V=0 to operating at a clear state at V≠0. In some embodiments, the LCs 408 may have negative dielectric anisotropy (Δε <0), and the opaque state and the transparent state of the dimming element 400 may be reversed, e.g., the dimming element 400 may operate at the clear state at V=0 and operate at the dark state at V≠0. In some embodiments, the dimming element 400 may not include a polarizer. In some embodiments, the dimming element 400 may include a polarizer (not shown), e.g., a wire grid polarizer disposed at the upper electrode layer 209-1, and the upper electrode layer 209-1 may be disposed between the polarizer and the upper alignment layer 404.

FIG. 4C illustrates an x-z sectional view of a dimming element 450, according to an embodiment of the disclosure. The dimming element 450 may include elements, structures, and/or functions that are the same as or similar to those included in the dimming element 400 shown in FIGS. 4A and 4B. Descriptions of the same or similar elements, structures, and/or functions can refer to the above descriptions rendered in connection with FIGS. 4A and 4B. The dimming element 450 may be an embodiment of the dimming element 166 show in FIG. 2D or FIG. 2E. The dimming element 450 may be a guest-host type LC dimming device including the dimming material layer 207 that includes the host LCs 408 and guest dyes doped into the LCs 408. In some embodiments, the guest dyes may include voltage-responsive or electric-field-responsive dyes (e.g., the dichroic dyes 410) and photo-responsive dyes 460. In some embodiments, the photo-responsive dyes 460 may include photochromic dyes, photodichroic dyes, or a combination thereof. As shown in FIG. 4C, the dimming element 450 may include the electrode layers (or electric conduction layers) 209-1 and 209-2 disposed at opposite sides of the dimming material layer 207, and the alignment layers 404 disposed at opposite surfaces of the dimming material layer 207. The alignment layers 404 are in direct contact with the dimming material layer 207.

In some embodiments, the photo-responsive dyes 460 may undergo reversible photo-isomerization between at least two stable states (or steady-states) having distinct light absorption effects. During the reversible photo-isomerization process, one or more physical properties of the photo-responsive dyes 460, such as absorption spectra, fluorescence emission, conjugation, electron conductivity, dipole interaction, and geometric shape may be changed when the photo-responsive dyes 460 are subject to an activating energy (e.g., an activating light irradiation). In some embodiments, the color of the photo-responsive dyes 460 may reversibly change depending on the presence or the absence of an activating light having a sufficiently high frequency, such as an ultraviolet (“UV”) light, a blue light, and/or a violet light. For example, the photo-responsive dyes 460 may change from a clear steady-state (or referred to as “a clear state”) to a dark steady-state (or referred to as “a dark state”) when exposed to a UV light (or when the intensity of the UV light is greater than a predetermined intensity), and may revert back to the clear steady-state in the absence of the UV light (or when the intensity of the UV light is lower than a predetermined intensity). The dark steady-state may also be referred to as a colored steady-state, as the photo-responsive dyes 460 may exhibit a grey or dark color tint at the dark steady-state. The clear steady-state may also be referred to as a colorless steady-state, as the photo-responsive dyes 460 may be visually transparent at the clear steady-state.

In some embodiments, the process of reverting back to the clear steady-state may be expedited by exposing the photo-responsive dyes 460 to other types of activating energy, such as a heat or an electromagnetic radiation. For example, in some embodiments, the photo-responsive dyes 460 may take a longer time to return to the clear steady-state in a low temperature environment, and may not achieve a substantially dark steady-state in a high temperature environment, as the photo-induced (e.g., UV-induced) transition to the dark steady-state may be countered by a thermally-induced rapid reversion to the clear steady-state. Such photo-responsive dyes 460 may be referred to as thermally-reversible photo-responsive dyes, which may return to the clear steady-state at a rate that is dependent on a temperature (e.g., an ambient temperature). In some embodiments, the photo-responsive dyes 460 may absorb lights of different wavelengths to drive transitions to both the dark and clear steady-states, where the ambient temperature may have negligible or no effect on a transition speed and steady-state (e.g., dark and clear steady-states) properties. Such photo-responsive dyes 460 may be referred to as thermally-stable photo-responsive dyes. In some embodiments, one or more infrared (“IR”), visible, and/or UV light sources may be arranged adjacent the photo-responsive dyes 460, and energized as needed to irradiate the photo-responsive dyes 460. For example, in some embodiments, the thermally-stable photo-responsive dyes 460 may absorb an activating light having a predetermined wavelength to change from the clear steady-state to the dark steady-state, and absorb a light having a wavelength different from the predetermined wavelength of the activating light to return to the clear steady-state.

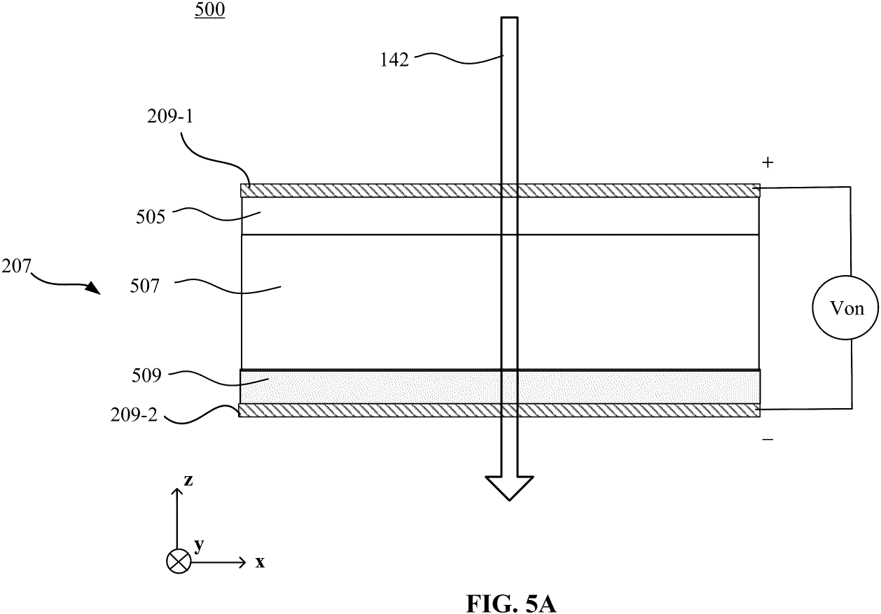

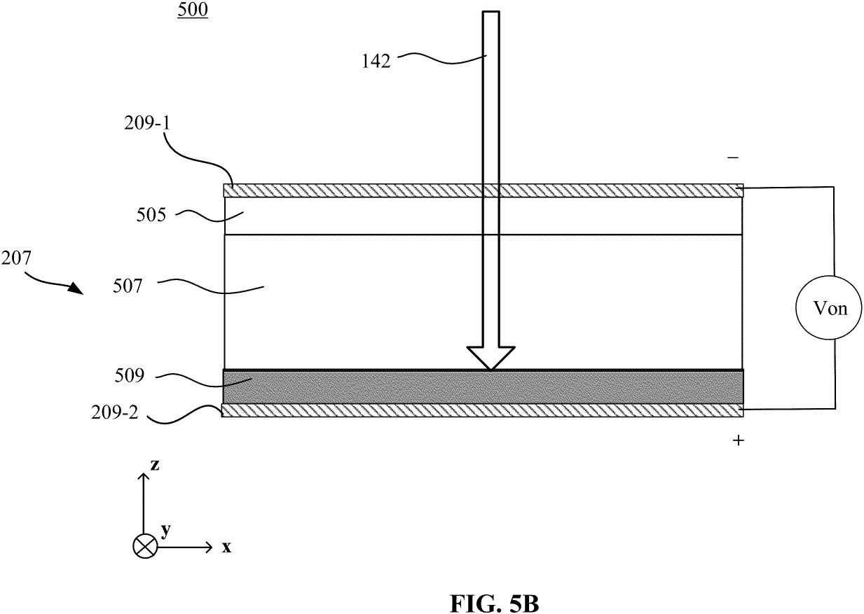

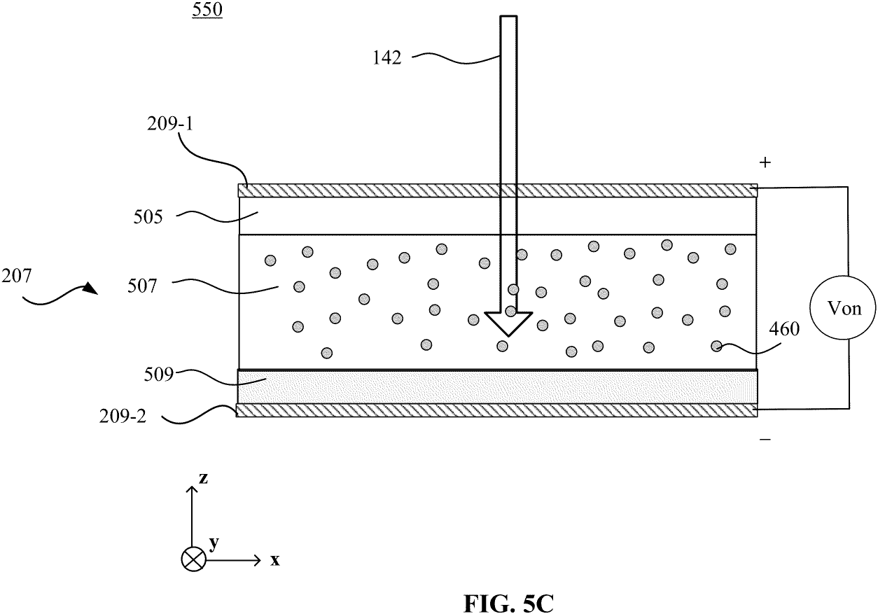

FIGS. 5A and 5B illustrate x-z sectional views of a dimming element 500, according to an embodiment of the disclosure. The dimming element 500 may be an embodiment of the dimming element 166 show in FIG. 2D or FIG. 2E. The dimming element 500 may be an electrochromic dimming device. As shown in FIG. 5A, the dimming element 500 may include the electrode layers 209-1 and 209-2 (collectively referred to as 209), and the dimming material layer 207 disposed between the electrode layers 209-1 and 209-2.

In the embodiment shown in FIG. 5A, the dimming material layer 207 may include at least one electrochromic layer configured with a light transmittance that is variable in response to a change in the applied electric field or current to create a visual effect. For discussion purpose, as shown in FIG. 5A, the dimming material layer 207 may include an ion storage layer 505, an ion-containing material layer 507 (e.g., an ion conductive layer or an electrolyte layer), and an electrochromic layer 509 arranged in a stacked configuration. The ion-containing material layer 507 may be disposed between the ion storage layer 505 and the electrochromic layer 509. The electrochromic layer 509 may include an electrochromic material, such as an electrochromic material of organic small molecules, an electrochromic material including a conducting polymer, or an electrochromic material including transition metal oxides, etc. The electrochromic material may reversibly alter its optical properties following electrochemical oxidation and reduction in response to an applied potential (e.g., an applied voltage). For example, a light transmittance of the electrochromic layer 509 may change upon the oxidation or reduction of the electrochromic material.

The ion storage layer 505 may function as a charge storage film that attracts and stores the oppositely charged counterparts to the ions that activate or deactivate the electrochromic layer 509. In some embodiments, the ion storage layer 505 may be configured to match the charge balance with the electrochromic layer upon the reversible oxidation/reduction reaction for color-switching of the electrochromic material contained in the electrochromic layer 509. For example, in some embodiments, the ion storage layer 505 may include an electrochromic material having color-switching reaction characteristics that are different from the electrochromic material included in the electrochromic layer 509. For example, when the electrochromic layer 509 includes a reductive electrochromic material, the ion storage layer 505 may include an oxidative electrochromic material. In some embodiments, the ion-containing material layer 507 may function as a medium for transporting ions between the ion storage layer 505 and the electrochromic layer 509. In some embodiments, the ion-containing material layer 507 may effectively block the electronic current while allowing the ions (typically protons (H⁺) or lithium ions (Li⁺)) to pass through.

During the operation of the dimming element 500, in some embodiments, as shown in FIG. 5A, a positive voltage may be applied to the electrode layer 209-1 and a negative voltage (or zero voltage) may be applied to the electrode layer 209-2. The direction of the external electric field generated in the dimming material layer 207 may along the -z-axis direction in FIG. 5A. The generated electric field may cause charge compensating ions, such as lithium, sodium, or hydrogen ions, to pass from the ion storage layer 505 into the electrochromic layer 509 via the ion-containing material layer 507. Meanwhile, electrons may be transported along the external circuit, and injected into the electrochromic layer 509. The injected electrons may yield an electrochemical reduction of the electrochromic material included in the electrochromic layer 509, resulting in a colorless (e.g., clear) state of the dimming device 500.

In some embodiments, as shown in FIG. 5B, a negative voltage (or zero voltage) may be applied to the electrode layer 209-1 and a positive may be applied to the electrode layer 209-2. The direction of the external electric field generated in the dimming material layer 207 may along the +z-axis direction in FIG. 5B. The generated electric field may cause the charge compensating ions to flow out of the electrochromic electrode layer 509, and flow back to the ion storage layer 505 via the ion-containing material layer 507. Meanwhile, the polarity reversal may cause the electrons to flow out of the electrochromic electrode layer 509, flow along the external circuit, and flow into the ion storage layer 505. The extraction of the electrons may result in an electrochemical oxidation of the electrochromic material included in the electrochromic layer 509, resulting in a colored (e.g., dark) state of the dimming element 500. Referring to FIGS. 5A and 5B, through reversing the polarity of the voltage applied to the dimming element 500, the dimming device element may be switchable between the colorless state and the colored state.

FIG. 5C illustrates an x-z sectional view of a dimming element 550, according to an embodiment of the disclosure. The dimming element 550 may be an embodiment of the dimming element 166 show in FIG. 2D or FIG. 2E. The dimming element 550 may be an electrochromic dimming element or a suspended particle dimming element. The dimming element 550 may include elements, structures, and/or functions that are the same as or similar to those included in the dimming element 500 shown in FIGS. 5A and 5B. Descriptions of the same or similar elements, structures, and/or functions can refer to the above descriptions rendered in connection with FIGS. 5A and 5B.

In the embodiment shown in FIG. 5C, the dimming material layer 207 may be configured to also include the photo-responsive dyes 460, such as photochromic dyes, photodichroic dyes, or a combination thereof. The photo-responsive dyes 460 may be doped into at least one of the ion storage layer 505, the ion-containing material layer 507, or the electrochromic layer 509. For discussion purposes, FIG. 5C shows that the photo-responsive dyes 460 are doped into the ion-containing material layer 507. In some embodiments, the photo-responsive dyes 460 may be doped into the electrochromic layer 509. In some embodiments, the photo-responsive dyes 460 may be doped into the ion storage layer 505.

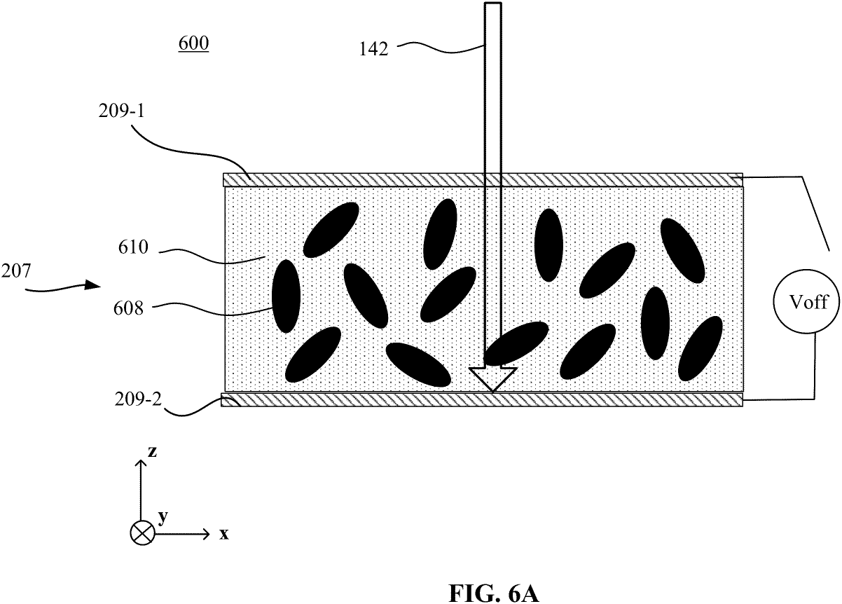

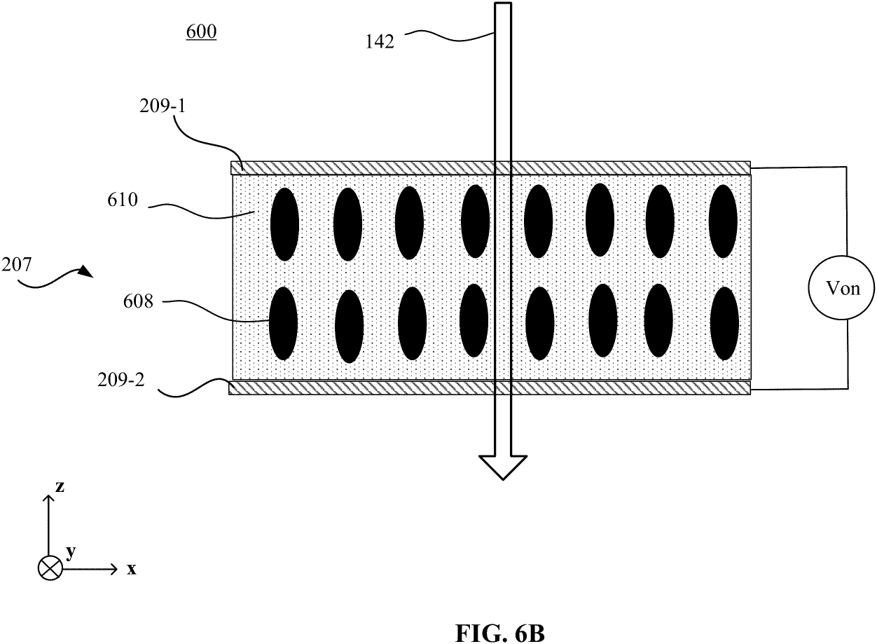

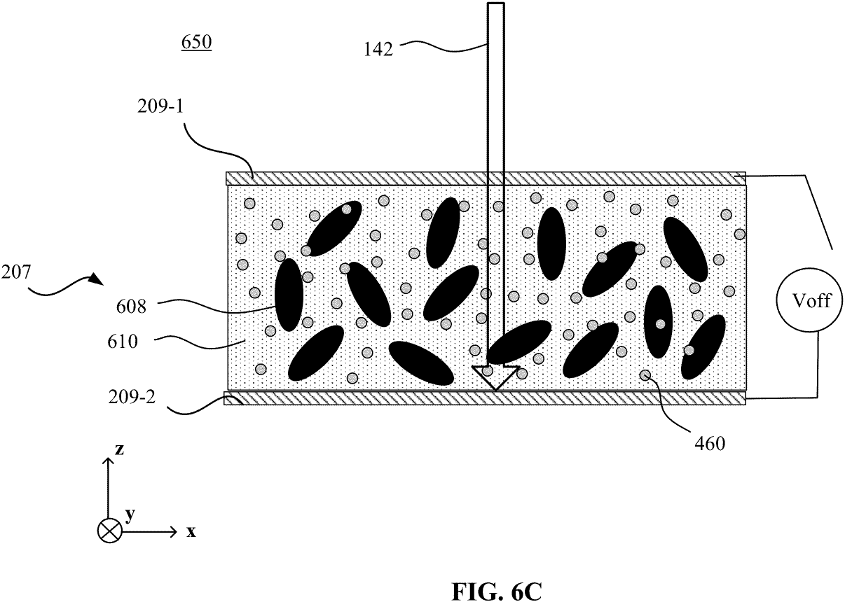

FIGS. 6A and 6B illustrate x-z sectional views of a dimming element 600, according to an embodiment of the disclosure. The dimming element 600 may be an embodiment of the dimming element 166 show in FIG. 2D or FIG. 2E. The dimming element 600 may be an electrophoretic dimming element. As shown in FIG. 6A, the dimming element 600 may include the electrode layers 209-1 and 209-2, and the dimming material layer 207 disposed between the two electrode layers 209-1 and 209-2. In the embodiment shown in FIG. 6A, the dimming material layer 207 may include microscopic particles 608 suspended in a liquid suspension or a polymer film 610. The particles 608 may be needle-shaped, rod-shaped, or lath-shaped, etc.

In a voltage-off state, as shown in FIG. 6A, the particles 608 suspended in the liquid suspension or film 610 may be randomly distributed or disordered due to Brownian movement, and the light 142 incident on the dimming material layer 207 may be absorbed and/or scattered. Thus, the light 142 incident on the dimming material layer 207 may not be transmitted through, and the dimming element 600 may operate in a dark state. In a voltage-on state, as shown in FIG. 6B, when the applied voltage is sufficiently high, the particles 608 may be uniformly oriented in the electric field direction, e.g., a z-axis direction in FIG. 6B, allowing the incident light 142 to be substantially transmitted therethrough. Thus, the dimming element 600 may operate in a clear state. After removing the voltage, the particles 608 may move back into a random pattern and substantially block the incident light 142. Thus, through varying the applied voltage, the light transmittance of the dimming element 600 may be tunable.

FIG. 6C illustrates an x-z sectional view of a dimming element 650, according to an embodiment of the disclosure. The dimming element 650 may be an embodiment of the dimming element 166 show in FIG. 2D or FIG. 2E. The dimming element 650 may be an electrochromic dimming element or a suspended particle dimming element. The dimming element 650 may include elements, structures, and/or functions that are the same as or similar to those included in the dimming element 600 shown in FIGS. 6A and 6B. Descriptions of the same or similar elements, structures, and/or functions can refer to the above descriptions rendered in connection with FIGS. 6A and 6B. In the embodiment shown in FIG. 6C, the dimming material layer 207 may be configured to also include the photo-responsive dyes 460, such as photochromic dyes, photodichroic dyes, or a combination thereof. The photo-responsive dyes 460 may be doped into the liquid suspension or polymer film 610, which may further enhance the dimming effect of the dimming element 650.

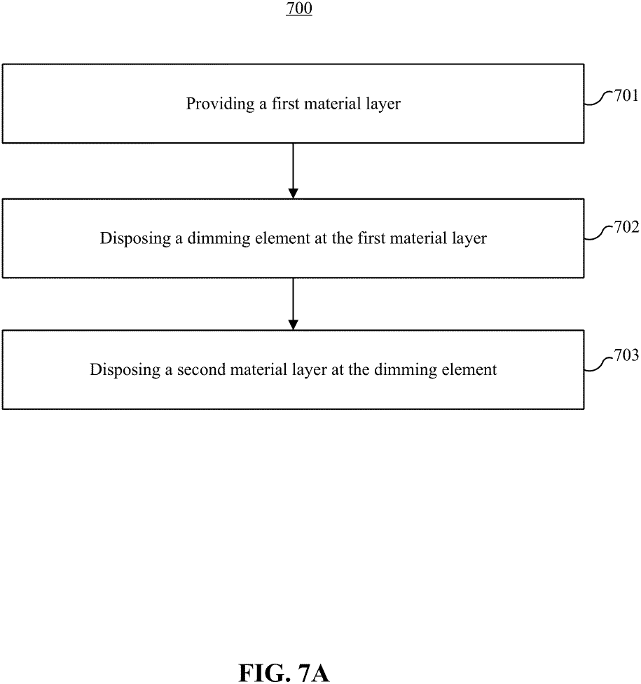

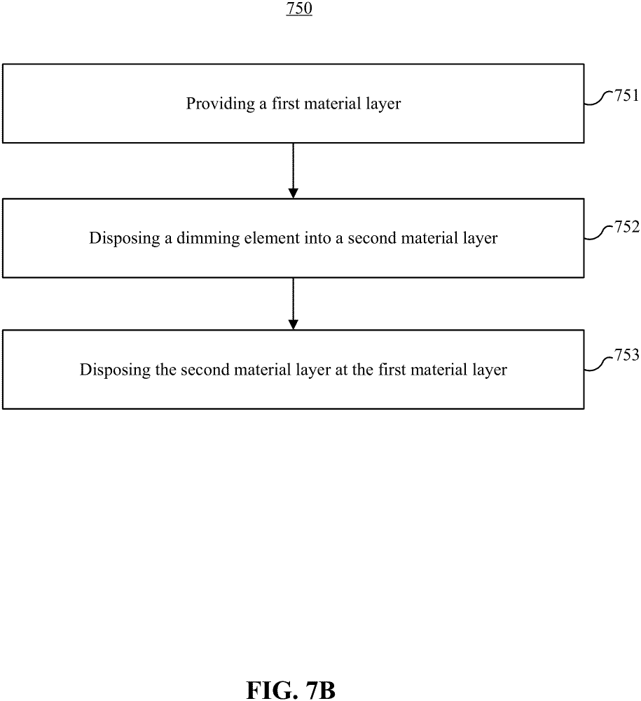

FIG. 7A is a flowchart illustrating a method 700 of fabricating a dimming lens, according to an embodiment of the present disclosure. The method 700 may include providing a first material layer (step 701). The first material layer may be disposed on a substrate. The method 700 may also include disposing a dimming element at the first material layer (step 702). The dimming element may be disposed at an inner surface (e.g., a concave surface) of the first material layer that faces an eye of a user when the fabricated dimming lens is used by the user. The method 700 may further include disposing a second material layer at the dimming element (step 703). The second material layer may be disposed at an inner surface of the dimming element that faces the eye of the user when the fabricated dimming lens is used by the user. The first material layer may include a first lens material that has a low density and a low birefringence, as described above. The second material layer may include a second lens material that has a high impact resistance, as described above. The density of the first lens material may be lower than the density of the second lens material. The birefringence of the first lens material may be lower than the birefringence of the second lens material. The impact resistance (or impact strength) of the second lens material may be higher (or stronger) than the impact resistance (or impact strength) of the first lens material. In some embodiments, after the first material layer is provided, the method 700 may include disposing the dimming element at the second material layer, and disposing a stack of the dimming element and the second material layer at the first material layer. For example, the stack of the dimming element and the second material layer may be disposed at an inner surface (e.g., a concave surface) of the first material layer that faces an eye of a user when the fabricated dimming lens is used by the user.

FIG. 7B is another flowchart illustrating a method 750 of fabricating a dimming lens, according to an embodiment of the present disclosure. The method 750 may include providing a first material layer (step 751), e.g., via injection molding. The method 750 may also include disposing a dimming element into a second material layer (step 752). For example, the step 752 may include encapsulating the dimming element into the second material layer via a suitable process. The method 750 may further include disposing the second material layer that includes the dimming element at the first material layer (step 753), e.g., via bonding through an optically clear adhesive. The second material layer may be disposed at an inner surface of the first material layer that faces the eye of the user when the fabricated dimming lens is used by the user. The first material layer may include a first lens material that has a low density and a low birefringence, as described above. The second material layer may include a second lens material that has a high impact resistance, as described above. The density of the first lens material may be lower than the density of the second lens material. The birefringence of the first lens material may be lower than the birefringence of the second lens material. The impact resistance (or impact strength) of the second lens material may be higher (or stronger) than the impact resistance (or impact strength) of the first lens material.

In some embodiments, the present disclosure provides a lens. The lens includes a first material layer including a first lens material with a first birefringence, a first density, and a first impact resistance. The lens also includes a second material layer coupled with the first material layer and including a second lens material with a second birefringence, a second density, and a second impact resistance. The first birefringence is lower than the second birefringence, the first density is lower than the second density, and the second impact resistance is stronger than the first impact resistance.

In some embodiments, the lens has an inner side facing an eye of a user and an outer side facing a real world environment, the first material layer is at the outer side of the lens, and the second material layer is at the inner side of the lens.

In some embodiments, the first material layer is configured with a non-zero optical power for providing a vision correction, and the second material layer is configured with a zero optical power or an optical power less than a predetermined value.

In some embodiments, the first lens material includes at least one of cyclic olefin copolymer or cyclic olefin polymer. The second lens material includes at least one of polycarbonate (“PC”), polymethyl methacrylate (“PMMA”), polyethylene (“PE”), or polypropylene (“PP”), or polyurethane.

In some embodiments, the first material layer has a concave surface, and the second material layer is laminated to the concave surface of the first material layer. In some embodiments, the lens also includes a dimming element disposed between the first material layer and the second material layer. In some embodiments, the dimming element includes a non-electrically tunable dimming material. In some embodiments, the non-electrically tunable dimming material includes at least one of a photochromic material, a photodichroic material, or a thermochromic material. In some embodiments, the dimming element includes a first electrode layer disposed at the first material layer and a second electrode layer disposed at the second material layer, and a dimming material disposed between the first electrode layer and the second electrode layer. In some embodiments, each of the first electrode layer and the second electrode layer includes at least one of indium tin oxide, Al-doped zinc oxide, graphene, poly(3,4-ethylenedioxythiophene): poly(styrene-sulfonate), carbon nanotubes, or silver nanowires.

In some embodiments, the dimming material includes an electrically tunable dimming material. The electrically tunable dimming material includes at least one of a guest-host liquid crystal (“LC”) material, a polymer stabilized cholesteric LC material, suspended particles, an electrochromic material, or an electrophoretic material. In some embodiments, the dimming material also includes a non-electrically tunable dimming material. In some embodiments, the second material layer includes a set of two second material layers, and the lens further comprises a dimming element disposed between the two second material layers.

In some embodiments, the lens also includes a dimming material doped into at least one of the first material layer or the second material layer. In some embodiments, the dimming material includes a non-electrically tunable dimming material.

In some embodiments, the present disclosure provides a system. The system includes a light source configured to output an image light. The system also includes an image combiner configured to guide the image light received from the light source to an eye-box region of the system, the image combiner having a first side facing the eye-box region and a second side facing a real world environment. The system also includes a lens disposed at the second side of the image combiner. The lens includes a first material layer including a first lens material with a first birefringence, a first density, and a first impact resistance. The lens also includes a second material layer coupled with the first material layer and including a second lens material with a second birefringence, a second density, and a second impact resistance. The first birefringence is lower than the second birefringence, the first density is lower than the second density, and the second impact resistance is stronger than the first impact resistance.

In some embodiments, the present disclosure provides a system. The system includes a light source configured to output an image light. The system also includes an image combiner configured to guide the image light received from the light source to an eye-box region of the system, the image combining including a first side facing the eye-box region and a second side facing a real world environment. The system also includes a lens disposed at the second side of the image combiner. The lens includes a first material layer including a first lens material with a first birefringence, a first density, and a first impact resistance. The lens also includes a second material layer coupled with the first material layer and including a second lens material with a second birefringence, a second density, and a second impact resistance. The first birefringence is lower than the second birefringence, the first density is lower than the second density, and the second impact resistance is stronger than the first impact resistance. The image combiner is at least partially embedded into the second material layer of the lens.

In some embodiments, the present disclosure provides a method. The method includes providing a first material layer including a first lens material with a first birefringence, a first density, and a first impact resistance. The method also includes disposing a dimming element at the first material layer. The method also includes disposing a second material layer at the dimming element. The second material layer includes a second lens material with a second birefringence, a second density, and a second impact resistance. The first birefringence is lower than the second birefringence, the first density is lower than the second density, and the second impact resistance is stronger than the first impact resistance. In some embodiments, disposing the dimming element at the first material layer includes laminating the dimming element onto a concave surface of the first material layer via an optical adhesive.

In some embodiments, a stack of the first material layer, the dimming element, and the second material layer forms a lens, the lens has an inner side facing an eye of a user and an outer side facing a real world environment, the first material layer is at the outer side of the lens, and the second material layer is at the inner side of the lens.

In some embodiments, the first material layer is configured with a customized optical power for providing a vision correction, and the second material layer is configured with a zero optical power or an optical power less than a predetermined value. In some embodiments, the first lens material includes at least one of cyclic olefin copolymer or cyclic olefin polymer. In some embodiments, the first material layer has a retardance value that is less than 100 nm. In some embodiments, the second lens material includes at least one of polycarbonate, polymethyl methacrylate, polyethylene, polypropylene, or polyurethane.

In some embodiments, the present disclosure provides a method. The method includes providing a first material layer including a first lens material with a first birefringence, a first density, and a first impact resistance. The method also includes disposing a dimming element into a second material layer, the second material layer including a second lens material with a second birefringence, a second density, and a second impact resistance. The method further includes disposing the second material layer at the first material layer. The first birefringence is lower than the second birefringence, the first density is lower than the second density, and the second impact resistance is stronger than the first impact resistance. In some embodiments, disposing the dimming element into the second material layer includes encapsulating the dimming element into the second material layer. In some embodiments, disposing the second material layer at the first material layer includes laminating the second material layer onto a concave surface of the first material layer via an optical adhesive.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the present disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a non-transitory computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A lens, comprising:
a first material layer including a first lens material with a first birefringence, a first density, and a first impact resistance; and
a second material layer coupled with the first material layer and including a second lens material with a second birefringence, a second density, and a second impact resistance,
wherein the first birefringence is lower than the second birefringence, the first density is lower than the second density, and the second impact resistance is stronger than the first impact resistance.

2. The lens of claim 1, wherein:
the lens has an inner side facing an eye of a user and an outer side facing a real world environment,
the first material layer is at the outer side of the lens, and
the second material layer is at the inner side of the lens.

3. The lens of claim 1, wherein:
the first material layer is configured with a customized optical power for providing a vision correction, and
the second material layer is configured with a zero optical power or an optical power less than a predetermined value.

4. The lens of claim 1, wherein the first lens material includes at least one of cyclic olefin copolymer or cyclic olefin polymer, and the second lens material includes at least one of polycarbonate, polymethyl methacrylate, polyethylene, polypropylene, or polyurethane.

5. The lens of claim 1, wherein the first material layer has a retardance value that is less than 100 nm.

6. The lens of claim 1, further comprising an optically clear adhesive layer disposed between the first material layer and the second material layer.

7. The lens of claim 1, wherein a center thickness of the first material layer is in a range of 1.0 mm to 1.5 mm, a center thickness of the second material layer is in a range of 0.2 mm to 0.7 mm, and the optically clear adhesive layer has a uniform thickness in a range of 0.01 mm to 0.2 mm.

8. The lens of claim 1, further comprising a dimming element disposed between the first material layer and the second material layer, the dimming element including at least one of a non-electrically tunable dimming material or an electrically tunable dimming material.

9. The lens of claim 1, wherein the second material layer includes a set of two second material layers, and the lens further includes a dimming element disposed between the two second material layers.

10. The lens of claim 1, further comprising a dimming material doped into at least one of the first material layer or the second material layer.

11. A method, comprising:
providing a first material layer including a first lens material with a first birefringence, a first density, and a first impact resistance;
disposing a dimming element at the first material layer; and
disposing a second material layer at the dimming element, the second material layer including a second lens material with a second birefringence, a second density, and a second impact resistance,
wherein the first birefringence is lower than the second birefringence, the first density is lower than the second density, and the second impact resistance is stronger than the first impact resistance.

12. The method of claim 11, wherein disposing the dimming element at the first material layer includes laminating the dimming element onto a concave surface of the first material layer via an optically clear adhesive layer.

13. The method of claim 11, wherein:
a stack of the first material layer, the dimming element, and the second material layer forms a lens,
the lens has an inner side facing an eye of a user and an outer side facing a real world environment,
the first material layer is at the outer side of the lens, and
the second material layer is at the inner side of the lens.

14. The method of claim 11, wherein:
the first material layer is configured with a customized optical power for providing a vision correction, and
the second material layer is configured with a zero optical power or an optical power less than a predetermined value.

15. The method of claim 11, wherein the first lens material includes at least one of cyclic olefin copolymer or cyclic olefin polymer, and the second lens material includes at least one of polycarbonate, polymethyl methacrylate, polyethylene, polypropylene, or polyurethane.

16. The method of claim 11, wherein the first material layer has a retardance value that is less than 100 nm.

17. A method, comprising:
providing a first material layer including a first lens material with a first birefringence, a first density, and a first impact resistance;
disposing a dimming element into a second material layer, the second material layer including a second lens material with a second birefringence, a second density, and a second impact resistance; and
disposing the second material layer at the first material layer,
wherein the first birefringence is lower than the second birefringence, the first density is lower than the second density, and the second impact resistance is stronger than the first impact resistance.

18. The method of claim 17, wherein disposing the dimming element into the second material layer includes encapsulating the dimming element into the second material layer.

19. The method of claim 17, wherein disposing the second material layer at the first material layer includes laminating the second material layer onto a concave surface of the first material layer via an optically clear adhesive layer.

20. The method of claim 17, wherein:
a stack of the first material layer, the dimming element, and the second material layer forms a lens,
the lens has an inner side facing an eye of a user and an outer side facing a real world environment,
the first material layer is at the outer side of the lens, and
the second material layer is at the inner side of the lens.
